(19) United States
(12) Patent Application Publication
(10) Pub. No.: US 2005/0251468 A1
(43) Pub. Date: Nov. 10, 2005

(54) Process management system

(76) Inventor: Jeff Scott Eder, Mill Creek, WA (US)

Correspondence Address: Jeff Eder, 19108 30th Drive SE, Mill Creek, WA, 98012, US

(21) Appl. No.: 11/167,685

(22) Filed: Jun. 27, 2005

Related U.S. Application Data
(63) Continuation of application No. 10/746,673, filed on Dec. 24, 2003.
Application No. 10/746,673 is a division of application No. 09/678,019, filed on Oct. 4, 2000, now abandoned.

(51) Int. Cl. G06F 17/60

(52) U.S. Cl. 705/35

(57) ABSTRACT

An automated method and system (100) for enhancing the operational effectiveness and optimizing the tangible financial impact of one or more enterprise processes on a continual basis.

### CONTINUATIION AND CROSS REFERENCE TO RELATED PATENTS AND APPLICATIONS

This application is a continuation of U.S. patent application Ser. No. 10/746,673 filed Dec. 24, 2003. U.S. patent application Ser. No. 10/746,673 is a divisional of U.S. patent application Ser. No. 09/678,019 filed Oct. 2, 2000 and abandoned on Dec. 29, 2003 which is incorporated herein by reference. The subject matter of this application is also related to the subject matter of U.S. Pat. No. 5,615,109 for “Method of and System for Generating Feasible, Profit Maximizing Requisition Sets”, by Jeff S. Eder, U.S. Pat. No. 6,321,205 for “Method of and System for Modeling and Analyzing Business Improvement Programs” by Jeff S. Eder and U.S. Pat. No. 6,393,406 for “Method of and System for valuing elements of a business enterprise” and application Ser. No. 09/940,450 filed Aug. 29, 2001 by Jeff S. Eder the disclosures of which are incorporated herein by reference. Application Ser. No. 09/940,450 is a continuation of application Ser. No. 09/421,553, filed Oct. 20, 1999. Application Ser. No. 09/421,553 was a continuation-in-part of application Ser. No. 09/358,969, filed Jul. 22, 1999, of application Ser. No. 09/295,337, filed Apr. 21, 1999, application Ser. No. 09/293,336, filed Apr. 16, 1999 and application Ser. No. 08/999,245, filed Dec. 10, 1997 the disclosures of which are incorporated herein by reference. The subject matter of this application is also related to the subject matter of U.S. patent application Ser. No. 09/688,982 filed Oct. 17, 2000, U.S. patent application Ser. No. 09/761,670 filed Jan. 18, 2001, U.S. patent application Ser. No. 09/761,671 filed Jan. 18, 2001, U.S. patent application Ser. No. 09/764,068 filed Jan. 19, 2001, U.S. patent application Ser. No. 09/938,874 filed Aug. 27, 2001, U.S. patent application Ser. No. 10/097,344 filed Mar. 16, 2002, U.S. patent application Ser. No. 10/282,113 filed Oct. 29, 2002, U.S. patent application Ser. No. 10/283,083 filed Oct. 30, 2002, U.S. patent application Ser. No. 10/287,586 filed Nov. 5, 2002, U.S. patent application Ser. No. 10/298,021 filed Nov. 18, 2002, U.S. patent application Ser. No. 10/441,385 filed May 20, 2003, U.S. patent application Ser. No. 10/645,099 filed Aug. 21, 2003, U.S. patent application Ser. No. 10/743,616 filed Dec. 22, 2003, U.S. patent application Ser. No. 10/743,417 filed Dec. 22, 2003, U.S. patent application Ser. No. 11/142,785 filed May 31, 2005, U.S. patent application Ser. No. 10/750,792 filed Jan. 3, 2004, U.S. patent application 09/688,983 filed Oct. 17, 2000, U.S. patent application Ser. No. 09/994,740 filed Nov. 28, 2001, U.S. patent application Ser. 10/012,374 filed Dec. 12, 2001, U.S. patent application Ser. No. 10/012,375 filed Dec. 12, 2001, U.S. patent application Ser. No. 10/025,794 filed Dec. 26, 2001, U.S. patent application Ser. No. 10/036,522 filed Jan. 7, 2002, U.S. patent application Ser. No. 10/061,665 filed Feb. 2, 2002, U.S. patent application Ser. No. 10/166,758 filed Jun. 12, 2002, U.S. patent application Ser. No. 10/329,172 filed Dec. 23, 2002, U.S. patent application Ser. No. 10/747,471 filed Dec. 29, 2003, U.S. patent application Ser. No. 10/821,504 filed Apr. 9, 2004, U.S. patent application Ser. No. 10/046,094 filed Jan. 16, 2002, U.S. patent application Ser. No. 10/071,164 filed Feb. 7, 2002, U.S. patent application Ser. No. 10/748,890 filed Dec. 30, 2003, U.S. patent application Ser. No. 10/861,014 filed Jun. 3, 2004, U.S. patent application Ser. No. 10/237,021 filed Sep. 9, 2002, U.S. patent application Ser. No. 10/242,154 filed Sep. 12, 2002 and U.S. patent application Ser. No. 10/717,026 filed Nov. 19, 2003 the disclosures of which are incorporated herein by reference.

### BACKGROUND OF THE INVENTION

This invention relates to a method of and system for improving the operational effectiveness and financial performance of one or more organization processes. These processes include interactive sales processes from e-commerce web sites, sales processes from on-line exchanges and sales processes completed with the support of off-line telemarketing centers.

### SUMMARY OF THE INVENTION

It is a general object of the present invention to provide a novel and useful system for improving the financial performance and operational effectiveness of one or more processes.

A preferable object to which the present invention is the improvement of the operational effectiveness and financial performance of an organization process and the organization that operates said processes. Organization level performance improvements are enabled by:
1) Learning from the data as required to develop a model of organization of market value that identifies the impact or contribution of each element of value to each category of value;
2) Systematically analyzing customer purchase patterns in a novel way that allows organizations to identify the products and services that drive purchase activity; and
3) Marrying the insight regarding “purchase activity drivers” with the improved understanding of organizational value available from the organization market value model as required to identify process changes that add value to the company.

The present invention also eliminates a great deal of time-consuming and expensive effort by automating the extraction of data from the databases, tables, and files of existing computer-based corporate finance, operations, human resource, supply chain, web-site and “soft” asset management system databases as required to operate the system. In accordance with the invention, the automated extraction, aggregation and analysis of data from a variety of existing computer-based systems significantly increases the scale and scope of the analysis that can be completed. The system of the present invention further enhances the efficiency and effectiveness of the business valuation by automating the retrieval, storage and analysis of information useful for valuing elements of value from external databases, publications and the internet. Uncertainty over which method is being used for completing the valuation and the resulting inability to compare different valuations is eliminated by the present invention by consistently utilizing the same set of valuation methodologies for valuing the different subsets of enterprise value as shown in Table 1.

TABLE 1

| Subset of Enterprise of Value | | Valuation methodology |
|---|---|---|
| Excess Cash & Marketable Securities (XS Cash) | | GAAP |
| Real options | | Real option algorithms |
| Market Sentiment | | Market Value* − (COPTOT + |
| | | ΣReal Option Values + XS |
| | | Cash) |
| Total Current-Operation Value (COPTOT): | | Income Valuation |
| Financial Assets: | Cash & Marketable Securities | GAAP |
| | (CASH) | |
| Financial Assets: | Accounts Receivable (AR) | GAAP |
| Financial Assets: | Inventory (IN) | GAAP |
| Financial Assets: | Prepaid Expenses (PE) | GAAP |
| Financial Assets: | Other Assets (OA) | Lower of GAAP or liquidation |
| | | value |
| Elements of | Production Equipment (PEQ) | If calculated value > liquidation |
| Value: | | value, then use system |
| | | calculated value, else use |
| | | liquidation value |
| Elements of | Intangible Elements (IE): | System calculated value for |
| Value: | Alliances, Brands, Customers, | each IE |
| | Customer Relationships, | |
| | Employees, Employee | |
| | Relationships, Infrastructure, | |
| | Intellectual Property, Information | |
| | Technology, Partnerships, | |
| | Processes, Vendors, Vendor | |
| | Relationships & Other Intangibles | |
| Elements of | General Going Concern Value | GCV = COPTOT − CASH − AR − |
| Value: | (GCV) | IN − PE − PEQ − OA − ΣIE |

The user also has the option of specifying the total value

The market value of the enterprise is calculated by combining the market value of all debt and equity as shown in Table 2.

TABLE 2

Enterprise Market Value = Σ Market value of enterprise equity −
Σ Market value of company debt

The experience of several of the most important companies in the U.S. economy, e.g. IBM, General Motors and DEC, in the late 1980s and early 1990s illustrates the problems that can arise when intangible asset information is omitted from corporate financial statements and companies focus only on the short term horizon. All three companies were showing large profits using current accounting systems while their businesses were deteriorating. If they had been forced to take write-offs when the declines in intangible assets were occurring, the problems would have been visible to the market and management would have been forced to act to correct the problems much more quickly than they actually did. These deficiencies of traditional accounting systems are particularly noticeable in high technology companies that are highly valued for their intangible assets and their options to enter growing markets rather than their tangible assets.

One benefit of the novel system is that the value contribution or impact of each element of value to the enterprise is subdivided in to three distinct categories of value: current operation, real options and market sentiment. The utility of the valuations produced by the system of the present invention are further enhanced by explicitly calculating the expected longevity of the different elements of value as required to improve the accuracy and usefulness of the valuations.

As shown in Tables 1, real options are valued using real option algorithms. Because real option algorithms explicitly recognize whether or not an investment is reversible and/or if it can be delayed, the values calculated using these algorithms are more realistic than valuations created using more traditional approaches like Net Present Value. The use of real option analysis for valuing real options gives the present invention a distinct advantage over traditional approaches to business valuation and performance management.

The innovative system has the added benefit of providing a large amount of detailed information concerning both tangible and intangible elements of value. Because intangible elements of value are by definition not tangible, they can not be measured directly. They must instead be measured by the impact they have on their surrounding environment. There are analogies in the physical world. For example, electricity is an “intangible” that is measured by the impact it has on the surrounding environment. Specifically, the strength of the magnetic field generated by the flow of electricity through a conductor is used to determine the amount of electricity that is being consumed. The system of the present invention measures intangible elements of value by identifying the attributes that, like the magnetic field, reflect the strength of the element in driving components of value (revenue, expense and change in capital), real options and market prices for company equity and are easy to measure. Once the attributes related to the strength of each element of value are identified, they can be summarized into a single expression (a composite variable or vector). The vectors for all elements of value are then evaluted to determine their relative contribution to driving each of the components of value. The system of the present invention calculates the product of the relative contribution of each element of value and forecast life to determine the contribution to each of the components of value. The contributions to each component of value are then added together to determine the current operation value of each element of value (see Table 5).

The system also gives the user the ability to track the changes in the elements of value by comparing the current valuations to previously calculated valuations. As such, the system provides the user with a long term measure of the effectiveness of customer acquisition and retention programs. To facilitate its use as a tool for improving the value of a commercial enterprise, the system of the present invention produces reports in formats that are similar to the reports provided by traditional accounting systems.

### BRIEF DESCRIPTION OF DRAWINGS

These and other objects, features and advantages of the present invention will be more readily apparent from the following description of one embodiment of the invention in which:

FIG. 1 is a block diagram showing the major processing steps of the present invention;

FIG. 2 is a diagram showing the files or tables in the application database of the present invention that are utilized for data storage and retrieval during the processing that improves the performance of an interactive sales process;

FIG. 3 is a block diagram of an implementation of the present invention;

FIG. 4 is a diagram showing the data windows that are used for receiving information from and transmitting information to the user (20) during system processing;

FIG. 5A, FIG. 5B, FIG. 5C, FIG. 5D, FIG. 5E and FIG. 5F are block diagrams showing the sequence of steps in the present invention used for specifying system settings and for initializing and operating the data bots that extract, aggregate, store and manipulate information utilized in system processing from: user input, the basic financial system database (5), the operation management system database (10), the web site transaction log database (12), the human resource information system database (15), the external database (25), the advanced financial system database (30), the soft asset management system databases (35), the supply chain system database (37) and the internet (40);

FIG. 6A, FIG. 6B and FIG. 6C are block diagrams showing the sequence of steps in the present invention that are utilized for initializing and operating the analysis bots;

FIG. 7 is a block diagram showing the sequence of steps in the present invention used for process optimization; and

FIG. 8 is a block diagram showing the sequence of steps in the present invention used in identifying customer segments for a sales process and communicating to the user.

### DETAILED DESCRIPTION OF ONE EMBODIMENT

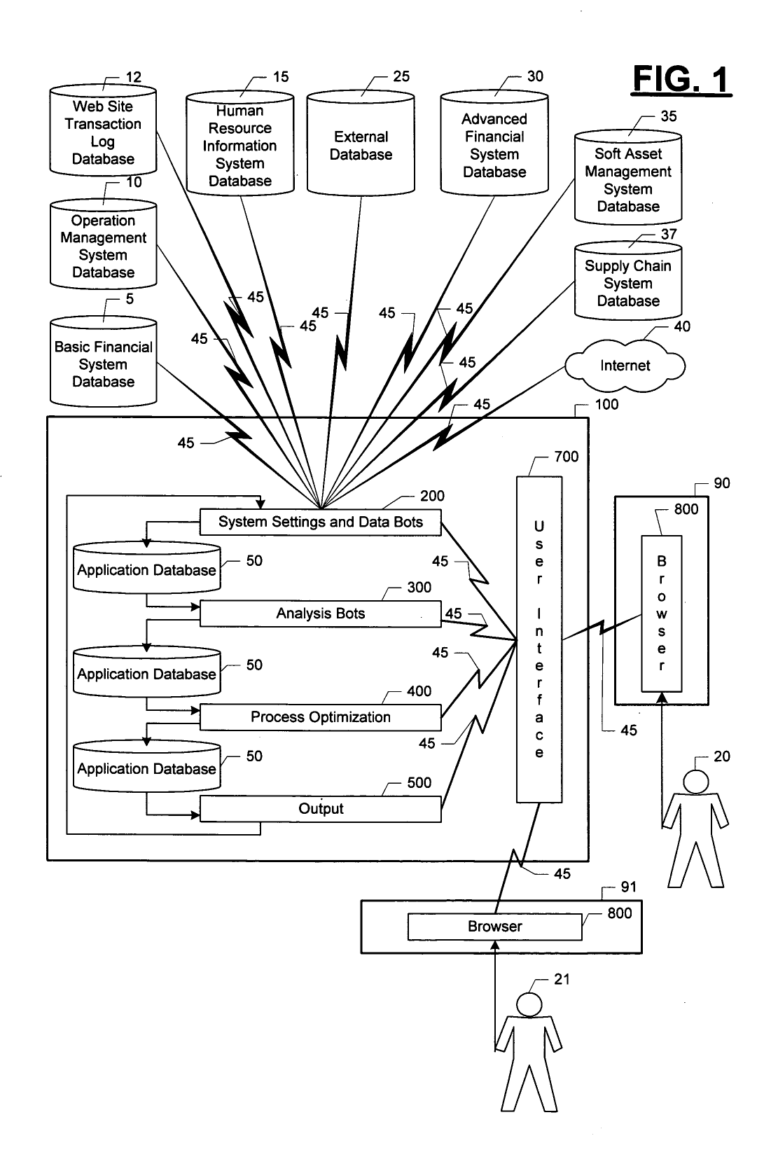

FIG. 1 provides an overview of the processing completed by the innovative system for improving the financial performance and operational effectiveness of an organization processes. In accordance with the present invention, an automated method of and system (100) for business valuation, activity analysis and promotion coordination is provided. Processing starts in this system (100) with the specification of system settings and the initialization and activation of software data “bots” (200) that extract, aggregate, manipulate and store the data and user (20) input required for completing system processing. This information is extracted via a network (45) from: a basic financial system database (5), an operation management system database (10), a web site transaction log database (12), a human resource information system database (15), an external database (25), an advanced financial system database (30), a soft asset management system database (35), a supply chain system database (37) and the internet (40). These information extractions and aggregations may be influenced by a user (20) through interaction with a user-interface portion of the application software (700) that mediates the display, transmission and receipt of all information to and from a browser (800) such as Microsoft Internet Explorer in an access device (90) such as a phone or personal computer that the user (20) interacts with. While only one database of each type (5, 10, 12, 15, 25, 30, 35 and 37) is shown in FIG. 1, it is to be understood that the system (100) can extract data from multiple databases of each type via the network (45). In one embodiment, the customer (21) communicates with the interactive sales processing system using an access device (91) such as a phone or personal computer that contains a browser (800) such as Microsoft Internet Explorer. One embodiment of the present invention contains a soft asset management system for each element of value of value being analyzed. Automating the extraction and analysis of data from each soft asset management system ensures that each soft asset is considered within the overall financial models for the enterprise. It should also be understood that it is possible to complete a bulk extraction of data from each database (5, 10, 12, 15, 25, 30, 35 and 37) via the network (45) using data extraction applications such as Data Transformation Services from Microsoft or Aclue from Decisionism before initializing the data bots. The data extracted in bulk could be stored in a single datamart or data warehouse where the data bots could operate on the aggregated data.

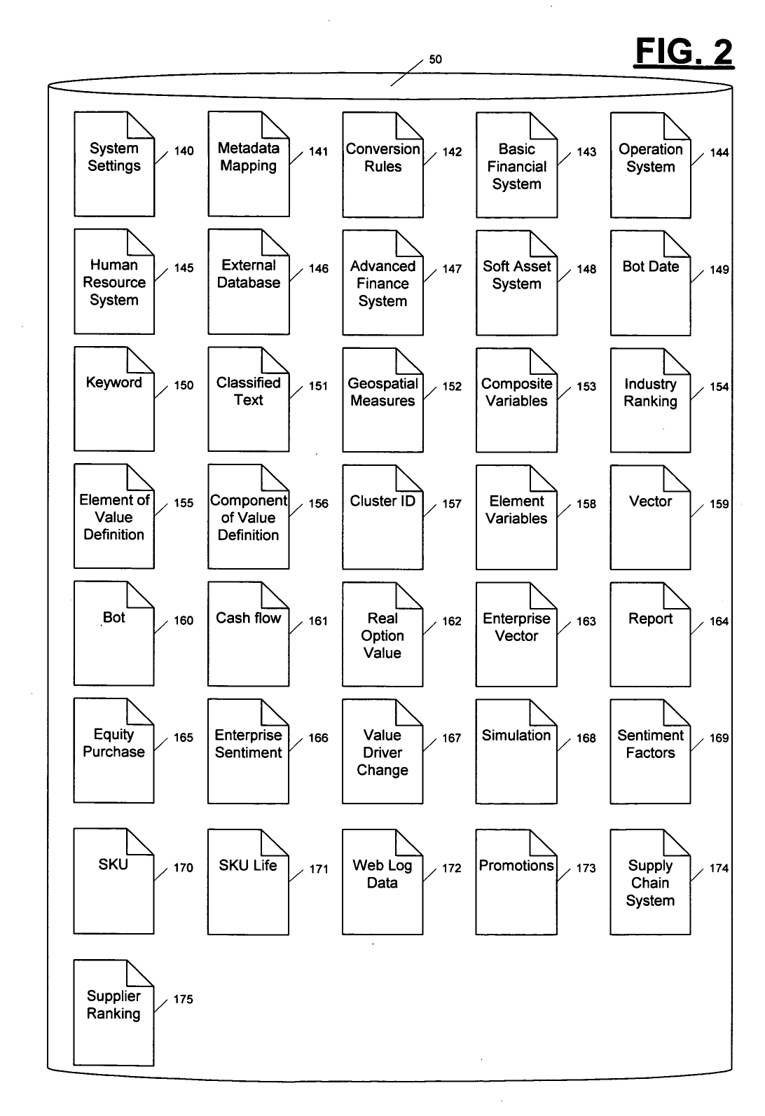

All extracted information is stored in a file or table (hereinafter, table) within an application database (50) as shown in FIG. 2. The application database (50) contains tables for storing user input, extracted information and system calculations including a system settings table (140), a metadata mapping table (141), a conversion rules table (142), a basic financial system table (143), an operation system table (144), a human resource system table (145), an external database table (146), an advanced finance system table (147), a soft asset system table (148), a bot date table (149), a keyword table (150), a classified text table (151), a geospatial measures table (152), a composite variables table (153), an industry ranking table (154), an element of value definition table (155), a component of value definition table (156), a cluster ID table (157), an element variables table (158), a vector table (159), a bot table (160), a cash flow table (161), a real option value table (162), an enterprise vector table (163), a report table (164), an equity purchase table (165), an enterprise sentiment table (166), a value driver change table (167), a simulation table (168), a sentiment factors table (169), an SKU table (170), an SKU life table (171), a web log data table (172), a optimized offer table (173), a supply chain system table (174) and a supplier ranking table (175). The application database (50) can optionally exist as a datamart, data warehouse or departmental warehouse. The system of the present invention has the ability to accept and store supplemental or primary data directly from user input, a data warehouse or other electronic files in addition to receiving data from the databases described previously. The system of the present invention also has the ability to complete the necessary calculations without receiving data from one or more of the specified databases. However, in one embodiment all required information is obtained from the specified data sources (5, 10, 12, 15, 25, 30, 35, 37 and 40).

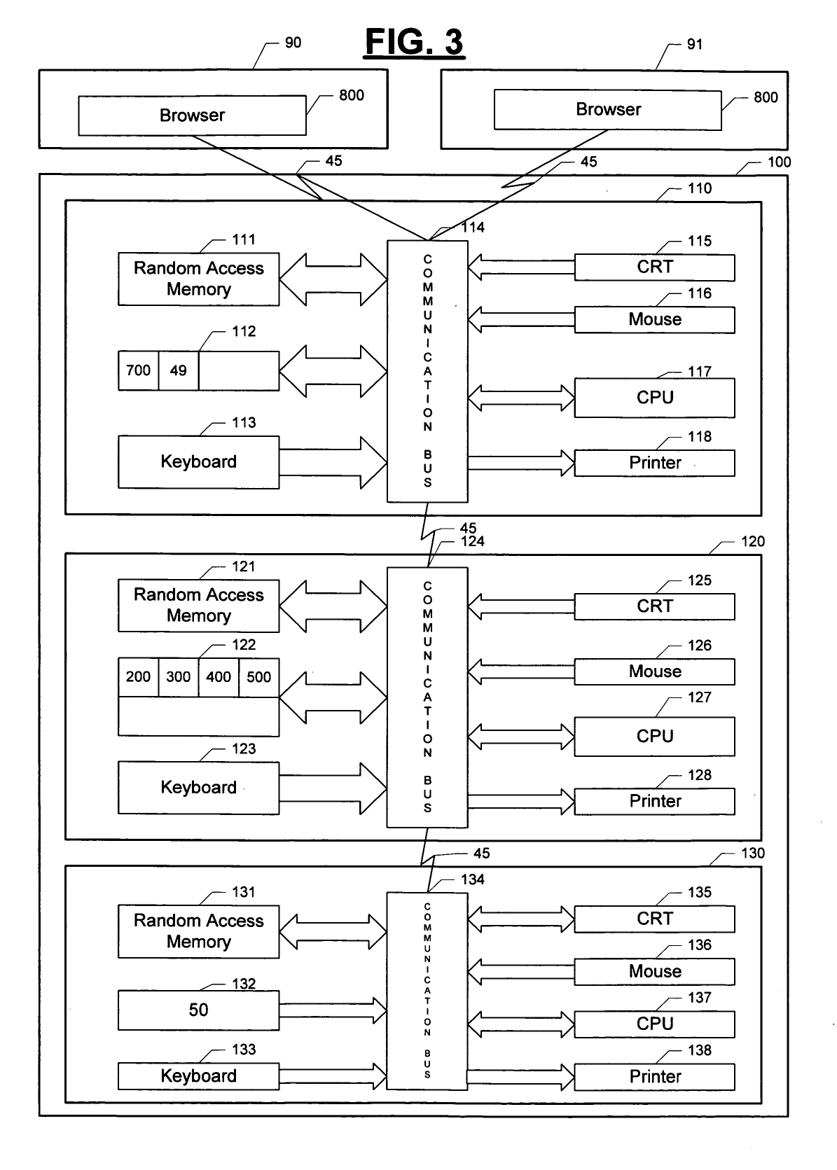

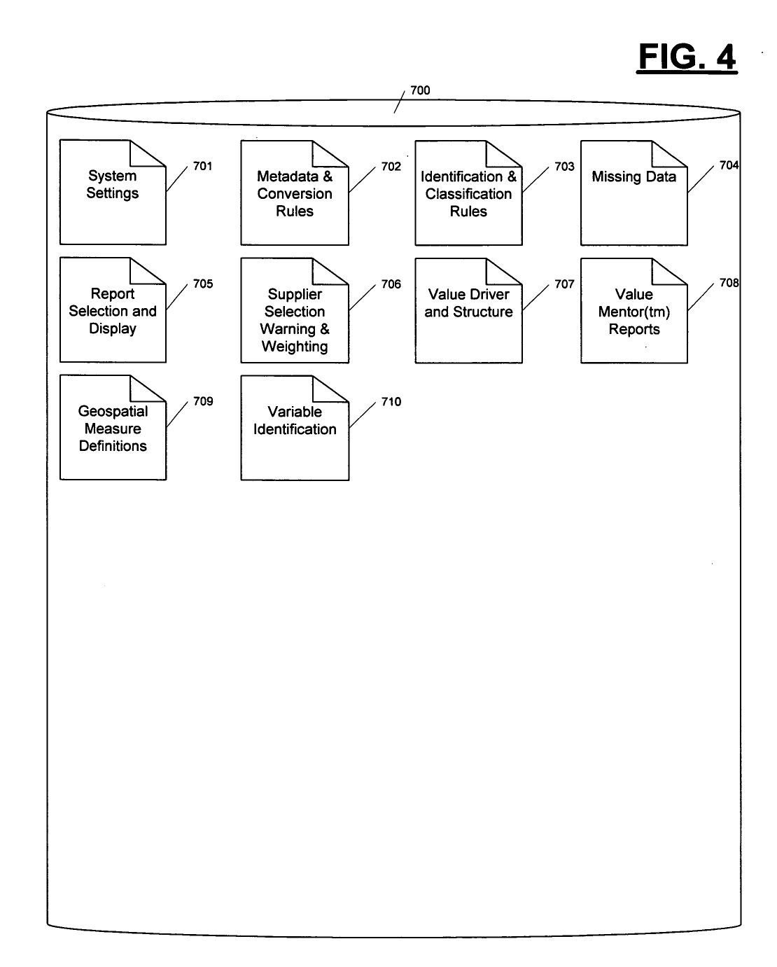

As shown in FIG. 3, one embodiment of the present invention is a computer system (100) illustratively comprised of a user-interface personal computer (110) connected to an application server personal computer (120) via a network (45). The application server personal computer (120) is in turn connected via the network (45) to a database-server personal computer (130). The user interface personal computer (110) is also connected via the network (45) to an internet browser appliance (90) that contains browser software (800) such as Microsoft Internet Explorer or Netscape Navigator.

The database-server personal computer (130) has a read/write random access memory (131), a hard drive (132) for storage of the application database (50), a keyboard (133), a communication bus (134), a CRT display (135), a mouse (136), a CPU (137) and a printer (138).

The application-server personal computer (120) has a, read/write random access memory (121), a hard drive (122) for storage of the non-user interface portion of the application software (200, 300, 400 and 500) of the present invention, a keyboard (123), a communication bus (124), a CRT display (125), a mouse (126), a CPU (127) and a printer (128). While only one client personal computer is shown in FIG. 3, it is to be understood that the application-server personal computer (120) can be networked to fifty or more client personal computers (110) via the network (45). The application-server personal computer (120) can also be networked to fifty or more server personal computers (130) via the network (45). It is to be understood that the diagram of FIG. 3 is merely illustrative of one embodiment of the present invention.

The user-interface personal computer (110) has a read/write random access memory (111), a hard drive (112) for storage of a client data-base (49) and the user-interface portion of the application software (700), a keyboard (113), a communication bus (114), a CRT display (115), a mouse (116), a CPU (117) and a printer (118).

The application software (200, 300, 400, 500 and 700) controls the performance of the central processing unit (127) as it completes the calculations required to complete the detailed business valuation, activity analysis and promotion coordination. In the embodiment illustrated herein, the application software program (200, 300, 400, 500 and 700) is written in a combination of C++and Visual Basic®. The application software (200, 300, 400, 500 and 700) can use Structured Query Language (SQL) for extracting data from the databases and the internet (5, 10, 12, 15, 25, 30, 35, 37 and 40). The user (20) can optionally interact with the user-interface portion of the application software (700) using the browser software (800) in the browser appliance (90) to provide information to the application software (200, 300, 400, 500 and 700) for use in determining which data will be extracted and transferred to the application database (50) by the data bots.

User input is initially saved to the client database (49) before being transmitted to the communication bus (124) and on to the hard drive (122) of the application-server computer via the network (45). Following the program instructions of the application software, the central processing unit (127) accesses the extracted data and user input by retrieving it from the hard drive (122) using the random access memory (121) as computation workspace in a manner that is well known.

The computers (110, 120 and 130) shown in FIG. 3 illustratively are IBM PCs or clones or any of the more powerful computers or workstations that are widely available. Typical memory configurations for client personal computers (110) used with the present invention should include at least 512 megabytes of semiconductor random access memory (111) and at least a 100 gigabyte hard drive (112). Typical memory configurations for the application-server personal computer (120) used with the present invention should include at least 2056 megabytes of semiconductor random access memory (121) and at least a 250 gigabyte hard drive (122). Typical memory configurations for the database-server personal computer (130) used with the present invention should include at least 4112 megabytes of semiconductor random access memory (135) and at least a 500 gigabyte hard drive (131).

Using the system described above, customer activity is analyzed, targeted promotions are developed and checked against supply chain availability and each element of value within the enterprise is analyzed as shown in Table 1. As shown in Table 1, the value of the current-operation will be calculated using an income valuation. An integral part of most income valuation models is the calculation of the present value of the expected cash flows, income or profits associated with the current-operation. The present value of a stream of cash flows is calculated by discounting the cash flows at a rate that reflects the risk associated with realizing the cash flow. For example, the present value (PV) of a cash flow of ten dollars ($10) per year for five (5) years would vary depending on the rate used for discounting future cash flows as shown below.

Discount rate = 25%

| | | | | | | | | | | |
|---|---|---|---|---|---|---|---|---|---|---|
| PV = | 10 | + | 10 | + | 10 | + | 10 | + | 10 | = 26.89 |
| | 1.25 | | (1.25)² | | (1.25)³ | | (1.25)⁴ | | (1.25)⁵ | |

Discount rate = 35%

| | | | | | | | | | | |
|---|---|---|---|---|---|---|---|---|---|---|
| PV = | 10 | + | 10 | + | 10 | + | 10 | + | 10 | = 22.20 |
| | 1.35 | | (1.35)² | | (1.35)³ | | (1.35)⁴ | | (1.35)⁵ | |

One of the first steps in evaluating the elements of value of current-operation value is extracting the data required to complete calculations in accordance with the formula that defines the value of the current-operation as shown in Table 4.

TABLE 4

Value of current-operation = (R) Value of forecast revenue from
current-operation (positive) + (E) Value of forecast expense for
current-operation (negative) + (C)* Value of current operation
capital change forecast
*Note:
(C) can have a positive or negative value

The three components of current-operation value will be referred to as the revenue value (R), the expense value (E) and the capital value (C). Examination of the equation in Table 4 shows that there are three ways to increase the value of the current-operation—increase the revenue, decrease the expense or decrease the capital requirements (note: this statement ignores a fourth way to increase value—decrease interest rate used for discounting future cash flows).

In one embodiment, the revenue, expense and capital requirement forecasts for the current operation, the real options and the contingent liabilities are obtained from an advanced financial planning system database (30) from an advanced financial planning system similar to the one disclosed in U.S. Pat. No. 5,615,109. The extracted revenue, expense and capital requirement forecasts are used to calculate a cash flow for each period covered by the forecast for the enterprise by subtracting the expense and change in capital for each period from the revenue for each period. A steady state forecast for future periods is calculated after determining the steady state growth rate the best fits the calculated cash flow for the forecast time period. The steady state growth rate is used to calculate an extended cash flow forecast. The extended cash flow forecast is used to determine the Competitive Advantage Period (CAP) implicit in the enterprise market value.

While it is possible to use analysis bots to sub-divide each of the components of current operation value into a number of sub-components for analysis, one embodiment has a pre-determined number of sub-components for each component of value for the enterprise. The revenue value is not subdivided. In one embodiment, the expense value is subdivided into five sub-components: the cost of raw materials, the cost of manufacture or delivery of service, the cost of selling, the cost of support and the cost of administration. The capital value is subdivided into six sub-components: cash, non-cash financial assets, production equipment, other assets (non-financial, non-production assets), financial liabilities and equity. The production equipment and equity sub-components are not used directly in evaluating the elements of value.

The components and sub-components of current-operation value will be used in valuing the elements and sub-elements of value. An element of value will be defined as “an identifiable entity or group of items that as a result of past transactions and other data has provided and/or is expected to provide economic benefit to an enterprise”. An item will be defined as a single member of the group that defines an element of value. For example, an individual salesman would be an “item” in the “element of value” sales staff. The data associated with performance of an individual item will be referred to as “item variables”.

Analysis bots are used to determine element of value lives and the percentage of: the revenue value, the expense value, and the capital value that are attributable to each element of value. The resulting values are then added together to determine the valuation for different elements of value as shown by the example in Table 5.

TABLE 5

| | | Element Life/ | |
|---|---|---|---|
| Gross Value | Percentage | CAP | Net Value |
| Revenue value = $120 M | 20% | 80% | Value = $19.2 M |
| Expense value = ($80 M) | 10% | 80% | Value = ($6.4) M |
| Capital value = ($5 M) | 5% | 80% | Value = ($0.2) M |
| Total value = $35 M | | | |

| | |
|---|---|
| Net value for this element of value: | Value = $12.6 M |

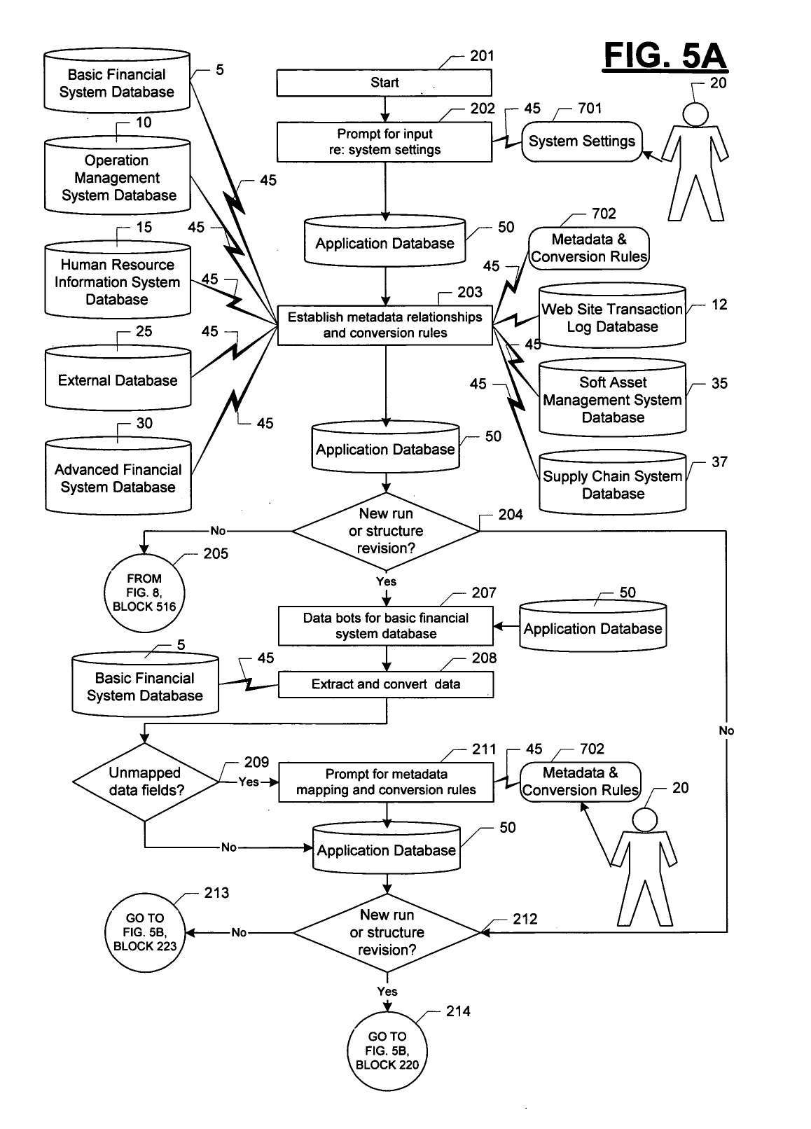

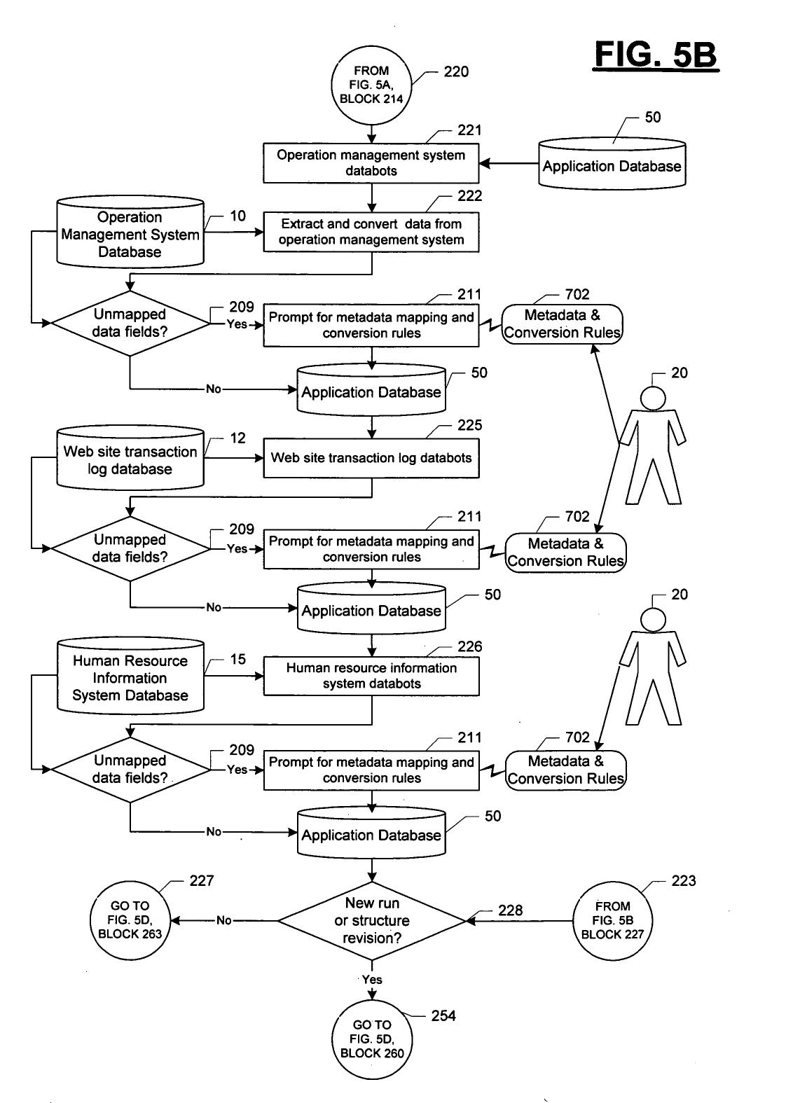

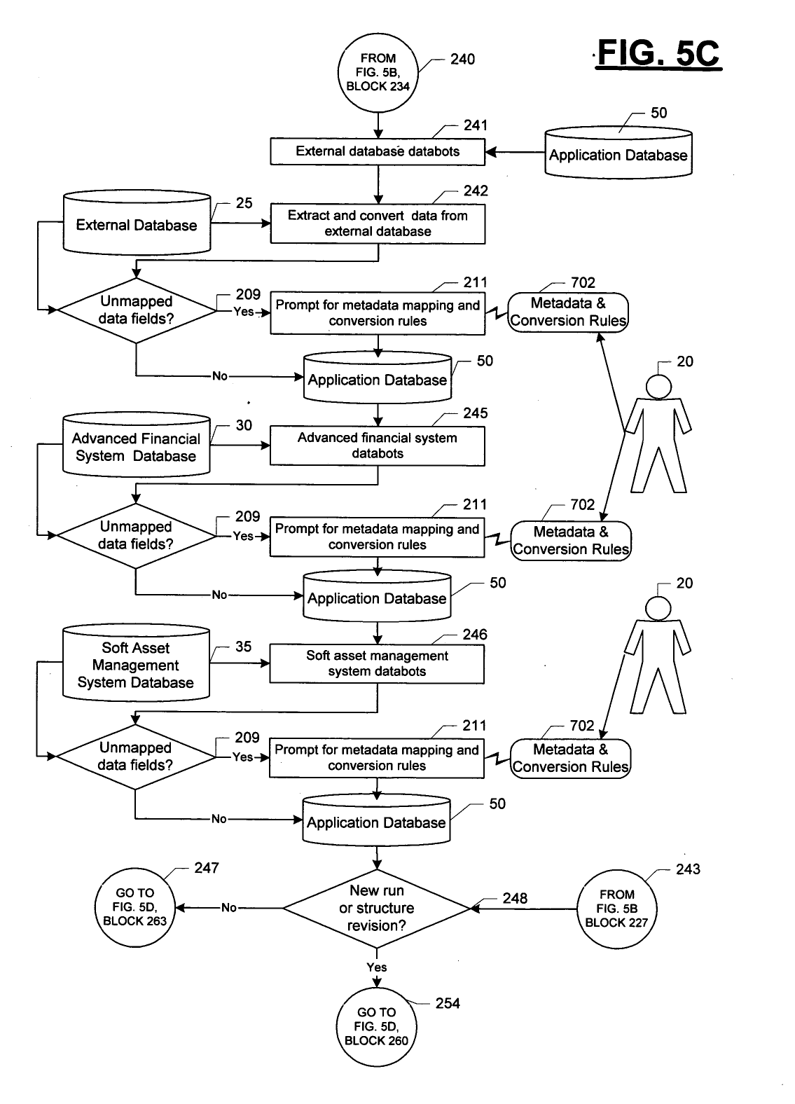

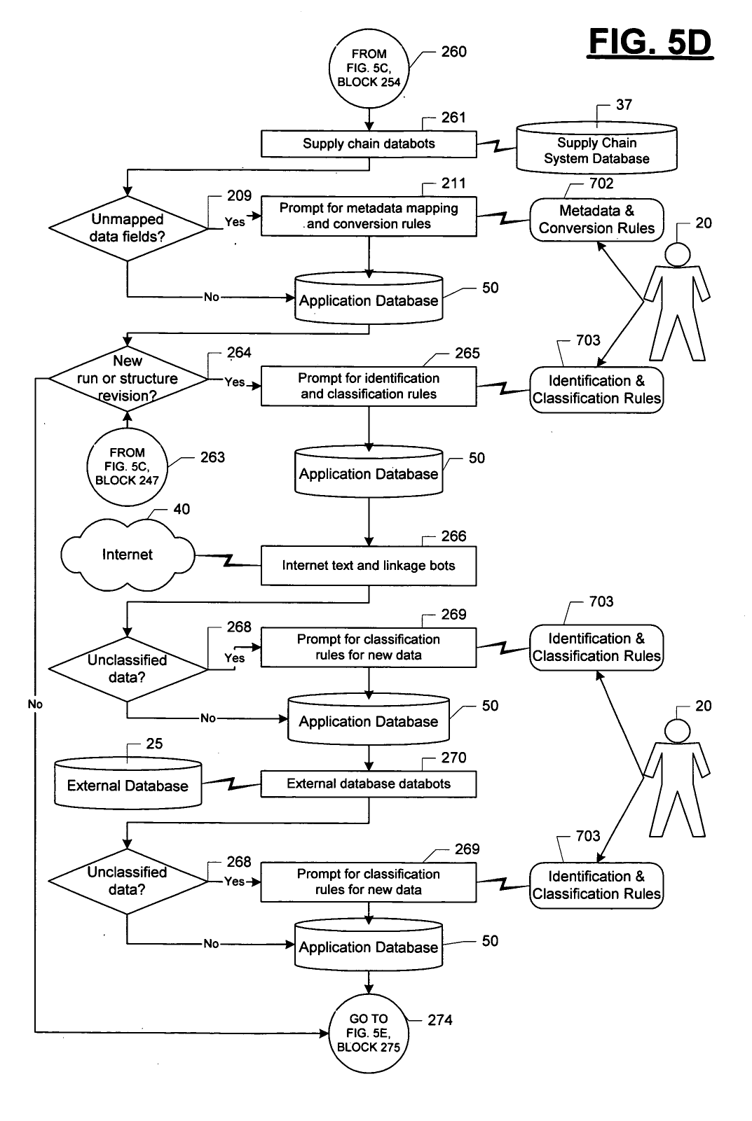

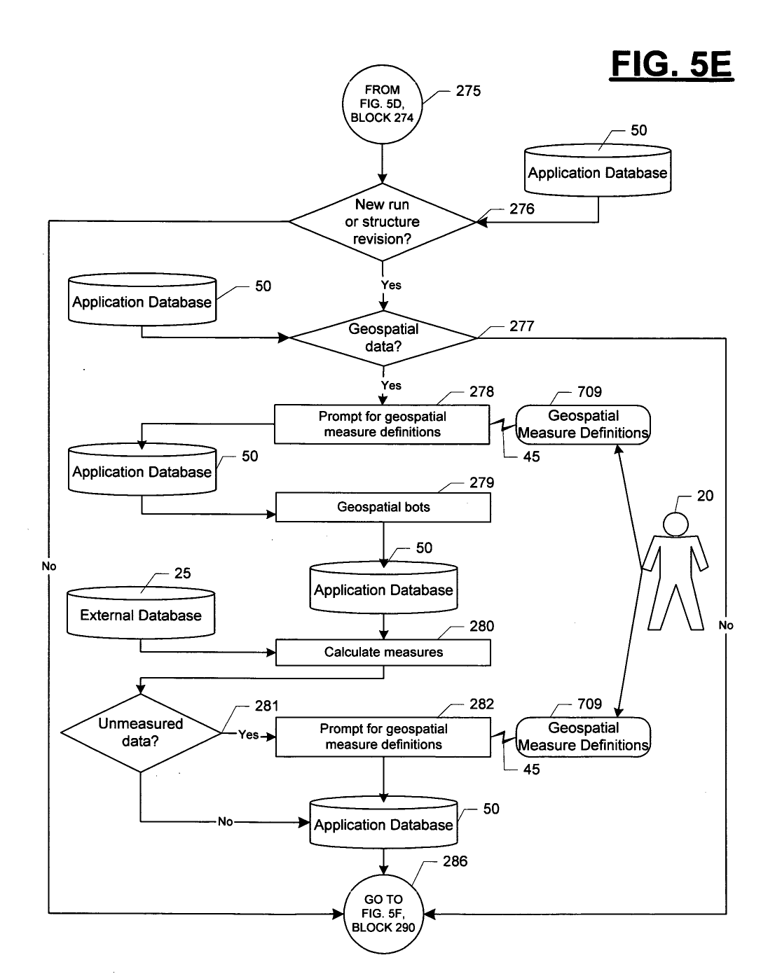

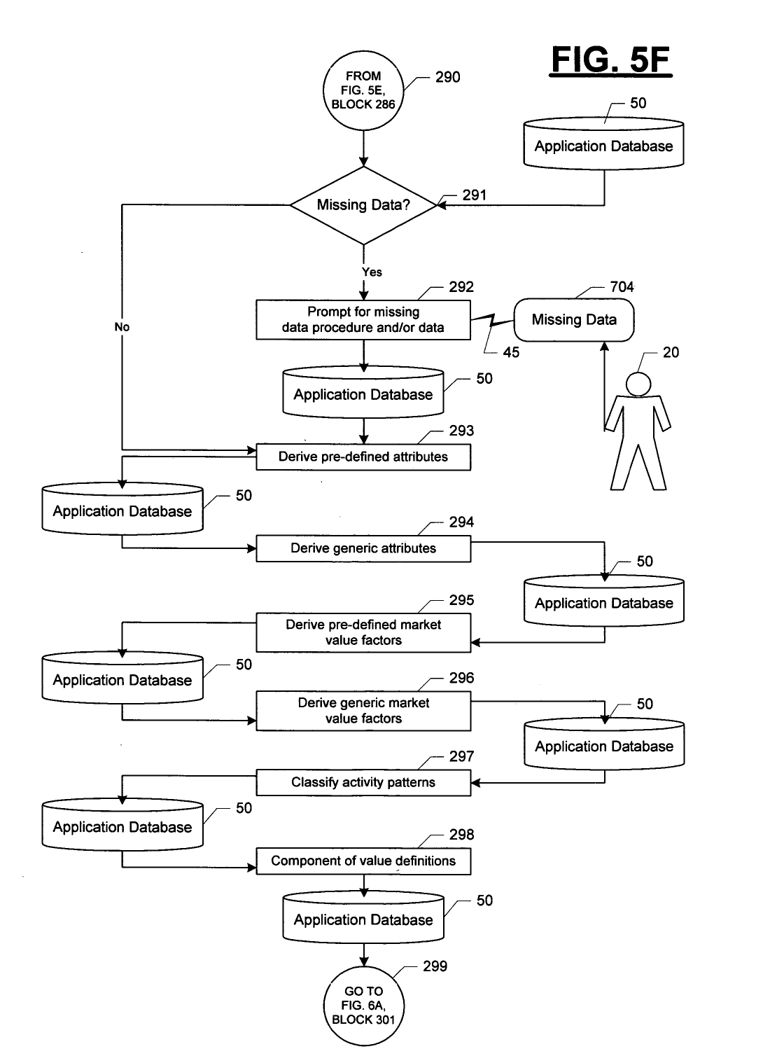

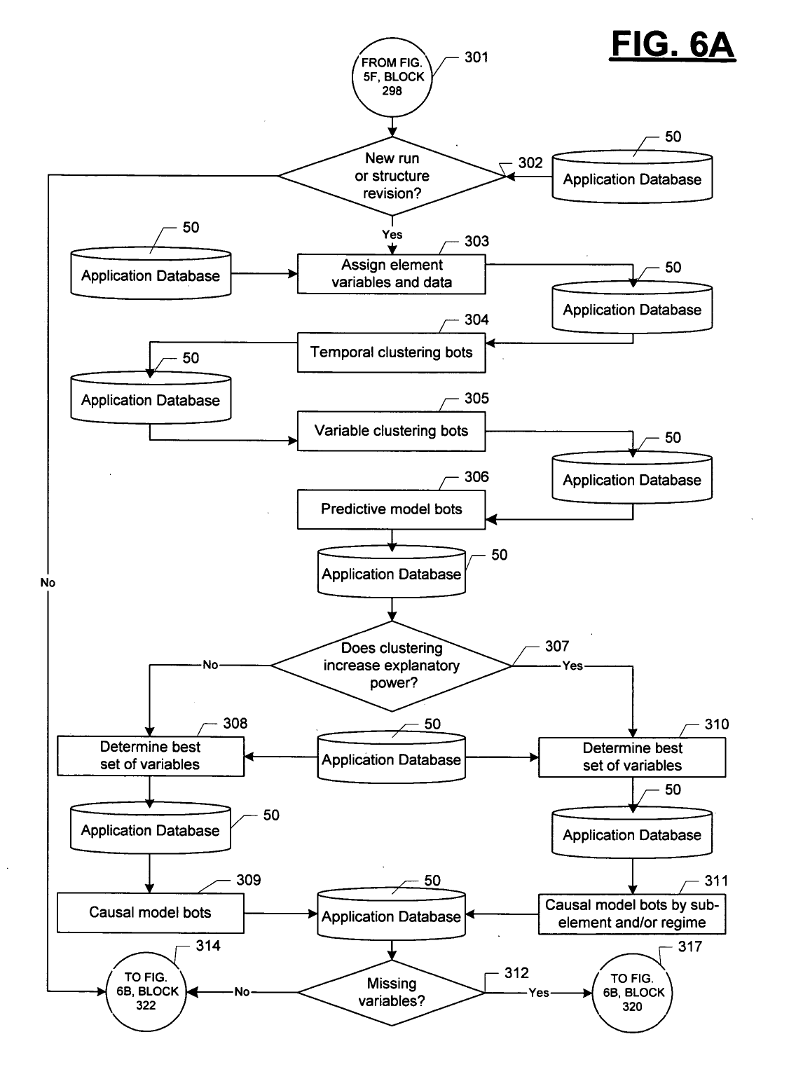

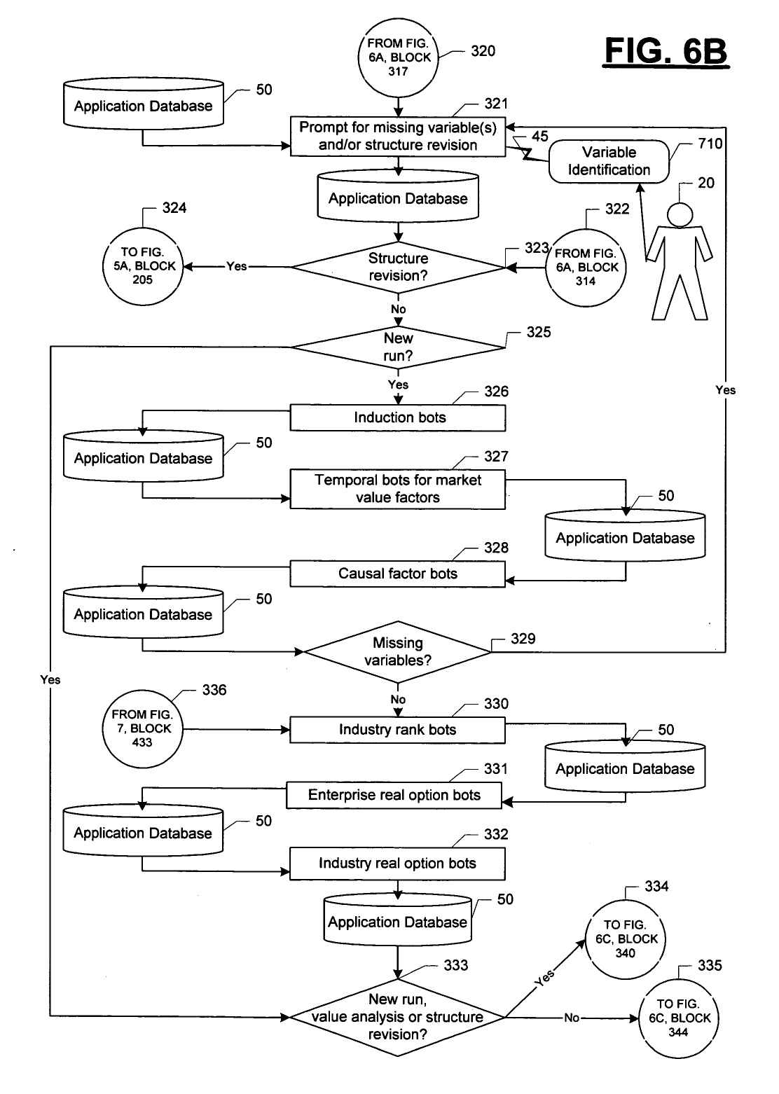

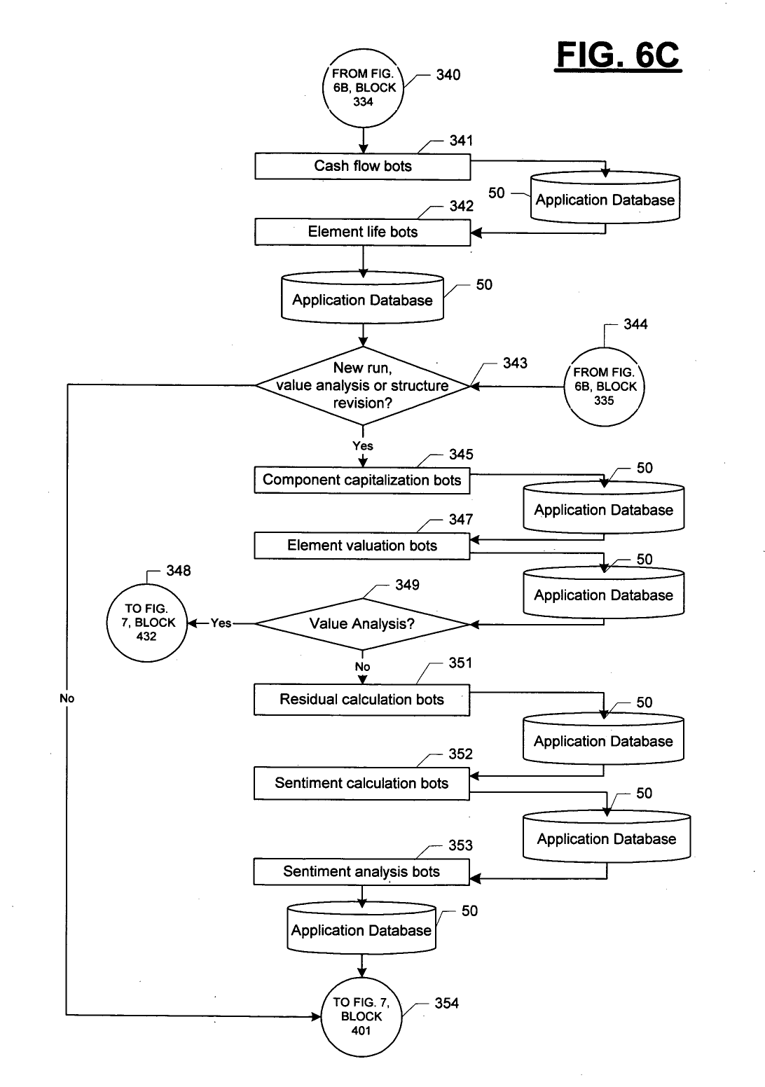

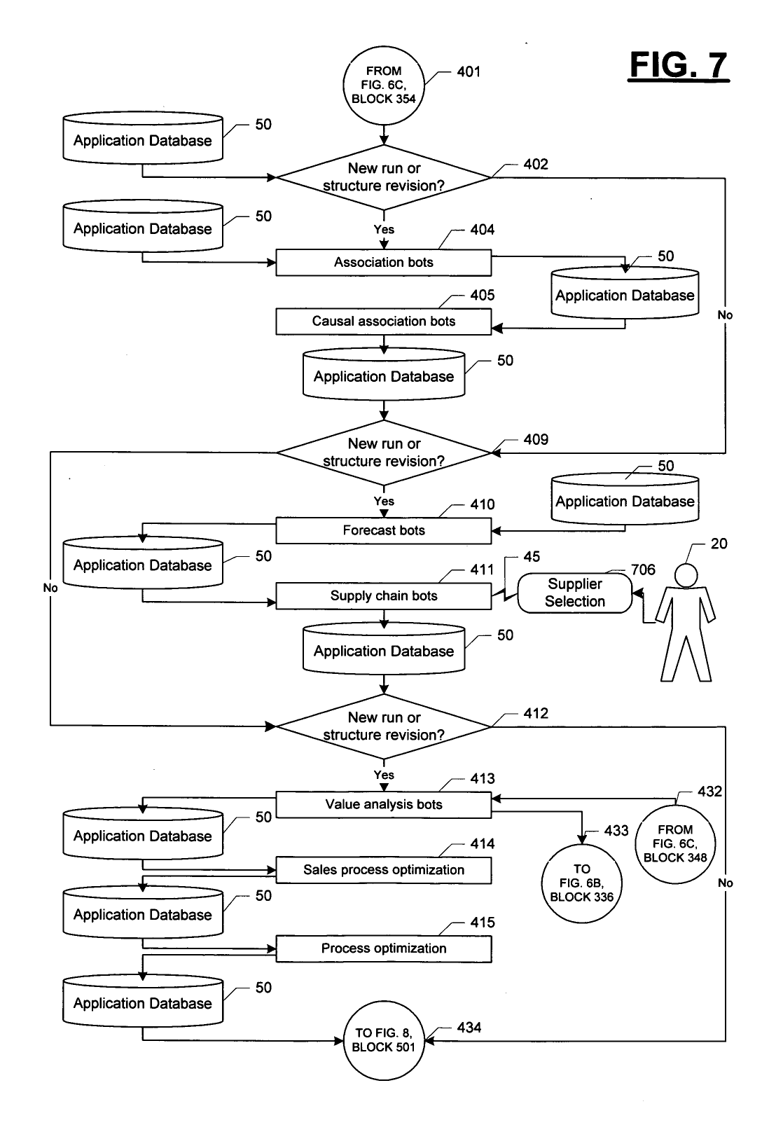

The business valuation, activity analysis and promotion coordination using the approach outlined above is completed in four distinct stages. As shown in FIG. 5A, FIG. 5B, FIG. 5C, FIG. 5D, FIG. 5E and FIG. 5F, the first stage of processing (block 200 from FIG. 1) programs bots to continually extract, aggregate, manipulate and store the data from user input and databases and the internet (5, 10, 12, 15, 25, 30, 35, 37 or 40) as required for the analysis of business value. Bots are independent components of the application that have specific tasks to perform. As shown in FIG. 6A, FIG. 6B and FIG. 6C the second stage of processing (block 300 from FIG. 1) programs analysis bots to continually learn from the data as required to generate a model of enterprise financial performance by:
1. Identifying the item variables, item performance indicators and composite variables for each element of value and sub-element of value that drive the components of value (revenue, expense and changes in capital) and the market price of company equity,
2. Creating vectors that summarize the performance of the item variables and item performance indicators for each element of value and sub-element of value,
3. Determining the appropriate cost of capital/discount rate on the basis of relative causal element of value strength and value the enterprise real options as well as the impact of each element of value on the real option discount rate;
4. Optionally determining the appropriate cost of capital, value and allocate the industry real options to the enterprise on the basis of relative causal element of value strength;
5. Determining the expected life of each element of value and sub-element of value;
6. Calculating the enterprise current operation value and value the revenue, expense and capital components of said current operation using the information prepared in the previous stage of processing;
7. Specifying and optimize predictive models to determine the relationship between the vectors determined in step 2 and the revenue, expense and capital component values determined in step 6,
8. Determining the causal factors for company stock price movement, calculate market sentiment and analyze the contribution of each element of value and sub-element of value to market sentiment, and
9. Combining the results of the third, seventh and eighth stages of processing to determine the value contribution of each element of value and sub-element of value to enterprise value by category of value.
   The third stage of processing (block 400 from FIG. 1) analyzes the supply chain status, volume purchase status, supplier value and customer value information as required to optimize the a plurality of processes by customer type. The fourth and final stage of processing (block 500 from FIG. 1) communicates via a web site with a customer (21), using an access device (91) with browser software (800), reviews potential purchases and places orders (in a call center application the system would provide the information to the tele-sales representative).

### System Settings and Data Bots

The flow diagrams in FIG. 5A, FIG. 5B, FIG. 5C, FIG. 5D, FIG. 5E and FIG. 5F detail the processing that is completed by the portion of the application software (200) that extracts, aggregates, transforms and stores the information required for system operation from the: basic financial system database (5), operation management system database (10), web site transaction log database (12), human resource information system database (15), external database (25), advanced financial system database (30), soft asset management system database (35), supply chain system database (37), the internet (40) and the user (20). A brief overview of the different databases will be presented before reviewing each step of processing completed by this portion (200) of the application software.

Corporate financial software systems are generally divided into two categories, basic and advanced. Advanced financial systems utilize information from the basic financial systems to perform financial analysis, financial planning and financial reporting functions. Virtually every commercial enterprise uses some type of basic financial system as they are required to use these systems to maintain books and records for income tax purposes. An increasingly large percentage of these basic financial systems are resident in microcomputer and workstation systems. Basic financial systems include general-ledger accounting systems with associated accounts receivable, accounts payable, capital asset, inventory, invoicing, payroll and purchasing subsystems. These systems incorporate worksheets, files, tables and databases. These databases, tables and files contain information about the company operations and its related accounting transactions. As will be detailed below, these databases, tables and files are accessed by the application software of the present invention as required to extract the information required for completing a business valuation. The system is also capable of extracting the required information from a data warehouse (or datamart) when the required information has been pre-loaded into the warehouse.

General ledger accounting systems generally store only valid accounting transactions. As is well known, valid accounting transactions consist of a debit component and a credit component where the absolute value of the debit component is equal to the absolute value of the credit component. The debits and the credits are posted to the separate accounts maintained within the accounting system. Every basic accounting system has several different types of accounts. The effect that the posted debits and credits have on the different accounts depends on the account type as shown in Table 6.

TABLE 6

| Account Type: | Debit Impact: | Credit Impact: |
|---|---|---|
| Asset | Increase | Decrease |
| Revenue | Decrease | Increase |
| Expense | Increase | Decrease |
| Liability | Decrease | Increase |
| Equity | Decrease | Increase |

General ledger accounting systems also require that the asset account balances equal the sum of the liability account balances and equity account balances at all times.

The general ledger system generally maintains summary, dollar only transaction histories and balances for all accounts while the associated subsystems, accounts payable, accounts receivable, inventory, invoicing, payroll and purchasing, maintain more detailed historical transaction data and balances for their respective accounts. It is common practice for each subsystem to maintain the detailed information shown in Table 7 for each transaction.

TABLE 7

| Subsystem | Detailed Information |
|---|---|
| Accounts | Vendor, Item(s), Transaction Date, Amount Owed, Due |
| Payable | Date, Account Number |
| Accounts | Customer, Transaction Date, Product Sold, Quantity, |
| Receivable | Price, Amount Due, Terms, Due Date, Account Number |
| Capital | Asset ID, Asset Type, Date of Purchase, Purchase Price, |
| Assets | Useful Life, Depreciation Schedule, Salvage Value |
| Inventory | Item Number, Transaction Date, Transaction Type, |
| | Transaction Qty, Location, Account Number |
| Invoicing | Customer Name, Transaction Date, Item(s) Sold, Amount |
| | Due, Due Date, Account Number |
| Payroll | Employee Name, Employee Title, Pay Frequency, Pay |
| | Rate, Account Number |
| Purchasing | Vendor, Item(s), Purchase Quantity, Purchase Price(s), Due |
| | Date, Account Number |

As is well known, the output from a general ledger system includes income statements, balance sheets and cash flow statements in well defined formats which assist management in measuring the financial performance of the firm during the prior periods when data input and system processing have been completed.

While basic financial systems are similar between firms, operation management systems vary widely depending on the type of company they are supporting. These systems typically have the ability to not only track historical transactions but to forecast future performance. For manufacturing firms, operation management systems such as Enterprise Resource Planning Systems (ERP), Material Requirement Planning Systems (MRP), Purchasing Systems, Scheduling Systems and Quality Control Systems are used to monitor, coordinate, track and plan the transformation of materials and labor into products. Systems similar to the one described above may also be useful for distributors to use in monitoring the flow of products from a manufacturer.

Operation Management Systems in manufacturing firms may also monitor information relating to the production rates and the performance of individual production workers, production lines, work centers, production teams and pieces of production equipment including the information shown in Table 8.

TABLE 8
Operation Management System - Production Information

```
  1. ID number (employee id/machine id)
  2. Actual hours - last batch
  3. Standard hours - last batch
  4. Actual hours - year to date
  5. Actual/Standard hours - year to date %
  6. Actual setup time - last batch
  7. Standard setup time - last batch
  8. Actual setup hours - year to date
  9. Actual/Standard setup hrs - yr to date %
10. Cumulative training time
11. Job(s) certifications
12. Actual scrap - last batch
13. Scrap allowance - last batch
14. Actual scrap/allowance - year to date
15. Rework time/unit last batch
16. Rework time/unit year to date
17. QC rejection rate - batch
18. QC rejection rate - year to date
```

Operation management systems are also useful for tracking requests for service to repair equipment in the field or in a centralized repair facility. Such systems generally store information similar to that shown below in Table 9.

TABLE 9
Operation Management System - Service Call Information

```
  1. Customer name
  2. Customer number
  3. Contract number
  4. Service call number
  5. Time call received
  6. Product(s) being fixed
  7. Serial number of equipment
  8. Name of person placing call
  9. Name of person accepting call
10. Promised response time
11. Promised type of response
12. Time person dispatched to call
13. Name of person handling call
14. Time of arrival on site
15. Time of repair completion
16. Actual response type
17. Part(s) replaced
18. Part(s) repaired
19. 2nd call required
20. 2nd call number
```

Web site transaction log databases keep a detailed record of every visit to a web site, they can be used to trace the path of each visitor to the web site and upon further analysis can be used to identify patterns that are most likely to result in purchases and those that are most likely to result in abandonment. If the customer (21) has previously visited the site and/or has been tagged by one of the web marketing vendors such as Avenue A or Double Click, the customer's browser appliance (91) may contain one or more “cookies” that identify the customer in sufficient detail to categorize him or her when they first connect with a web site. This information can be used to develop a personalized greeting, such as “Welcome Back Tom!” This information can also be used to identify which promotion would generate the most value for the company using the system. Web site transaction logs generally contain the information shown in Table 10.

TABLE 10
Web Site Transaction Log Database

```
  1. Customer's URL
  2. Date and time of visit
  3. Pages visited
  4. Length of page visit (time)
  5. Type of browser used
  6. Referring site
  7. URL of site visited next
  8. Downloaded file volume and type
  9. Cookies
10. Transactions
```

Computer based human resource systems may some times be packaged or bundled within enterprise resource planning systems such as those available from SAP, Oracle and Peoplesoft. Human resource systems are increasingly used for storing and maintaining corporate records concerning active employees in sales, operations and the other functional specialties that exist within a modern corporation. Storing records in a centralized system facilitates timely, accurate reporting of overall manpower statistics to the corporate management groups and the various government agencies that require periodic updates. In some cases human resource systems include the company payroll system as a subsystem. In one embodiment of the present invention, the payroll system is part of the basic financial system. These systems can also be used for detailed planning regarding future manpower requirements. Human resource systems typically incorporate worksheets, files, tables and databases that contain information about the current and future employees. As will be detailed below, these databases, tables and files are accessed by the application software of the present invention as required to extract the information required for completing a business valuation. It is common practice for human resource systems to store the information shown in Table 11 for each employee.

TABLE 11
Human Resource System Information

```
  1. Employee name
  2. Job title
  3. Job code
  4. Rating
  5. Division
  6. Department
  7. Employee No./(Social Security Number)
  8. Year to date - hours paid
  9. Year to date - hours worked
10. Employee start date - company
11. Employee start date - department
12. Employee start date - current job
13. Training courses completed
14. Cumulative training expenditures
15. Salary history
16. Current salary
17. Educational background
18. Current supervisor
```

External databases can be used for obtaining information that enables the definition and evaluation of a variety of things including elements of value, market value factors, industry real options and composite variables. In some cases information from these databases can be used to supplement information obtained from the other databases and the internet (5, 10, 12, 15, 30, 35, 37 and 40). In the system of the present invention, the information extracted from external databases (25) can be in the forms listed in Table 12.

TABLE 12
Types of information

| | |
|---|---|
| 1) | Numeric information such as that found in the |
| | SEC Edgar database and the databases |
| | of financial infomediaries such as FirstCall, |
| | IBES and Compustat, |
| 2) | Text information such as that found in the Lexis |
| | Nexis database and databases containing past |
| | issues from specific publications, |
| 3) | Cookie information such as that provided by web |
| | intermediaries that helps identify the type of |
| | customer connected to the company web site, |
| 4) | Multimedia information such as video |
| | and audio clips, and |
| 5) | Geospatial data. |

The system of the present invention uses different “bot” types to process each distinct data type from external databases (25). The same “bot types” are also used for extracting each of the different types of data from the internet (40). The system of the present invention must have access to at least one external database (25) that provides information regarding the equity prices for the enterprise and the equity prices and financial performance of competitors.

Advanced financial systems may also use information from external databases (25) and the internet (40) in completing their processing. Advanced financial systems include financial planning systems and activity based costing systems. Activity based costing systems may be used to supplement or displace the operation of the expense component analysis segment of the present invention as disclosed previously. Financial planning systems generally use the same format used by basic financial systems in forecasting income statements, balance sheets and cash flow statements for future periods. Management uses the output from financial planning systems to highlight future financial difficulties with a lead time sufficient to permit effective corrective action and to identify problems in company operations that may be reducing the profitability of the business below desired levels. These systems are most often developed by individuals within companies using two and three dimensional spreadsheets such as Lotus 1-2-3®, Microsoft Excel® and Quattro Pro®. In some cases, financial planning systems are built within an executive information system (EIS) or decision support system (DSS). For one embodiment of the present invention, the advanced financial system database (30) is similar to the financial planning system database detailed in U.S. Pat. No. 5,165,109 for “Method of and System for Generating Feasible, Profit Maximizing Requisition Sets”, by Jeff S. Eder, the disclosure of which is incorporated herein by reference.

While advanced financial planning systems have been around for some time, soft asset management systems are a relatively recent development. Their appearance is further proof of the increasing importance of “soft” assets. Soft asset management systems include: alliance management systems, brand management systems, customer relationship management systems, channel management systems, intellectual property management systems, process management systems and vendor management systems. Soft asset management systems are similar to operation management systems in that they generally have the ability to forecast future events as well as track historical occurrences. Customer relationship management systems are the most well established soft asset management systems at this point and will the focus of the discussion regarding soft asset management system data. In firms that sell customized products, the customer relationship management system is generally integrated with an estimating system that tracks the flow of estimates into quotations, orders and eventually bills of lading and invoices. In other firms that sell more standardized products, customer relationship management systems generally are used to track the sales process from lead generation to lead qualification to sales call to proposal to acceptance (or rejection) and delivery. All customer relationship management systems would be expected to track all of the customer's interactions with the enterprise after the first sale and store information similar to that shown below in Table 13.

TABLE 13
Customer Relationship Management System - Information

| | |
|---|---|
| 1. | Customer/Potential customer name |
| 2. | Customer number |
| 3. | Address |
| 4. | Phone number |
| 5. | Source of lead |
| 6. | Date of first purchase |
| 7. | Date of last purchase |
| 8. | Last sales call/contact |
| 9. | Sales call history |
| 10. | Sales contact history |
| 11. | Sales history: product/qty/price |
| 12. | Quotations: product/qty/price |
| 13. | Custom product percentage |
| 14. | Payment history |
| 15. | Current A/R balance |
| 16. | Average days to pay |

Supply chain management system databases (37) contain information that may have been in operation management system databases (10) in the past. These systems provide enhanced visibility into the availability of goods and promote improved coordination between customers and their suppliers. All supply chain management systems would be expected to track all of the items ordered by the enterprise after the first purchase and store information similar to that shown below in Table 14.

TABLE 14
Supply Chain System Information

| | |
|---|---|
| 1. | Stock keeping unit |
| 2. | Vendor |
| 3. | Total quantity on order |
| 4. | Total quantity in transit |
| 5. | Total quantity on back order |
| 6. | Total quantity in inventory |
| 7. | Quantity available today |
| 8. | Quantity available next 7 days |
| 9. | Quantity available next 30 days |
| 10. | Quantity available next 90 days |
| 11. | Quoted lead time |
| 12. | Actual average lead time |

System processing of the information from the different databases (5, 10, 12, 15, 25, 30, 35 and 37) and the internet (40) described above starts in a block 201, FIG. 5A, which immediately passes processing to a software block 202. The software in block 202 prompts the user (20) via the system settings data window (701) to provide system setting information. The system setting information entered by the user (20) is transmitted via the network (45) back to the application server (120) where it is stored in the system settings table (140) in the application database (50) in a manner that is well known. The specific inputs the user (20) is asked to provide at this point in processing are shown in Table 15.

TABLE 15

| | |
|---|---|
| 1. | New run or structure revision? |
| 2. | Continuous, If yes, frequency? (hourly, daily, |
| | weekly, monthly or quarterly) |
| 3. | Structure of enterprise (department, etc.) |
| 4. | Enterprise checklist |
| 5. | Base account structure |
| 6. | Metadata standard (XML or MetaData Coalition) |
| 7. | Location of basic financial system database and metadata |
| 8. | Location of advanced financial system database and metadata |
| 9. | Location of human resource information system |
| | database and metadata |
| 10. | Location of operation management system database and metadata |
| 11. | Location of soft asset management system databases and metadata |
| 12. | Location of external database and metadata |
| 13. | Location of web site transaction log database and metadata |
| 14. | Location of supply chain management system database and metadata |
| 15. | Location of account structure |
| 16. | Base currency |
| 17. | Location of database and metadata for equity information |
| 18. | Location of database and metadata for debt information |
| 19. | Location of database and metadata for tax rate information |
| 20. | Location of database and metadata for currency conversion |
| | rate information |
| 21. | Geospatial data? If yes, identity of geocoding service. |
| 22. | The maximum number of generations to be processed without |
| | improving fitness |
| 23. | Default clustering algorithm (selected from list) and maximum |
| | cluster number |
| 24. | Amount of cash and marketable securities required for day |
| | to day operations |
| 25. | Total cost of capital (weighted average cost of equity, |
| | debt and risk capital) |
| 26. | Number of months a product is considered new after |
| | it is first produced |
| 27. | Enterprise industry segments (SIC Code) |
| 28. | Primary competitors by industry segment |
| 29. | Management report types (text, graphic, both) |
| 30. | Default reports |
| 31. | Default missing data procedure |
| 32. | Maximum time to wait for user input |
| 33. | Maximum discount rate for new projects (real option valuation) |
| 34. | Generic promotions (coupons, rebates, etc.) |
| 35. | Maximum number of sub-elements of value |
| 36. | Maximum number of customer segments |

The enterprise checklists are used by a “rules” engine (such as the one available from Neuron Data) in block 202 to influence the number and type of items with pre-defined metadata mapping for each category of value. For example, if the checklists indicate that the enterprise is focused on branded, consumer markets, then additional brand related factors will be pre-defined for mapping. The application of these system settings will be further explained as part of the detailed explanation of the system operation.

The software in block 202 can use the current system date to determine the time periods (months) that require data in order to complete the current operation and the real option valuations and stores the resulting date range in the system settings table (140). In one embodiment the valuation of the current operation by the system utilizes basic financial, advanced financial, soft asset management, external database and human resource data for the three year period before and the three year forecast period after the current date. The user (20) also has the option of specifying the data periods that will be used for completing system calculations.

After the storage of system setting data is complete, processing advances to a software block 203. The software in block 203 prompts the user (20) via the metadata and conversion rules window (702) to map metadata using the standard specified by the user (20) (XML or the Metadata Coalitions specification) from the basic financial system database (5), the operation management system database (10), the web site transaction log database (12), the human resource information system database (15), the external database (25), the advanced financial system database (30), the soft asset management system database (35) and the supply chain system database (37) to the enterprise hierarchy stored in the system settings table (140) and to the pre-specified fields in the metadata mapping table (141). Pre-specified fields in the metadata mapping table include: the revenue, expense and capital components and sub-components for the enterprise and pre-specified fields for expected value drivers. Because the bulk of the information being extracted is financial information, the metadata mapping often takes the form of specifying the account number ranges that correspond to the different fields in the metadata mapping table (141). Table 16 shows the base account number structure that the account numbers in the other systems must align with. For example, using the structure shown below, the revenue component for the enterprise could be specified as enterprise 01, any department number, accounts 400 to 499 (the revenue account range) with any sub-account.

TABLE 16

| | Account Number | | | |
|---|---|---|---|---|
| | 01 - | 902 (any) - | 477 - | 86 (any) |
| Segment | Enterprise | Department | Account | Sub-account |
| Subgroup | Workstation | Marketing | Revenue | Singapore |
| Position | 4 | 3 | 2 | 1 |

As part of the metadata mapping process, any database fields that are not mapped to pre-specified fields are defined by the user (20) as component of value, elements of value or non-relevant attributes and “mapped” in the metadata mapping table (141) to the corresponding fields in each database in a manner identical to that described above for the pre-specified fields. After all fields have been mapped to the metadata mapping table (141), the software in block 203 prompts the user (20) via the metadata and conversion rules window (702) to provide conversion rules for each metadata field for each data source. Conversion rules will include information regarding currency conversions and conversion for units of measure that may be required to accurately and consistently analyze the data. The inputs from the user (20) regarding conversion rules are stored in the conversion rules table (142) in the application database. When conversion rules have been stored for all fields from every data source, then processing advances to a software block 204.

The software in block 204 checks the system settings table (140) in the application database (50) to determine if the current calculation is a new calculation or a structure change. If the calculation is not a new calculation or a structure change then processing advances to a software block 212. Alternatively, if the calculation is new or a structure change, then processing advances to a software block 207.

The software in block 207 checks the bot date table (149) and deactivates any basic financial system data bots with creation dates before the current system date and retrieves information from the system settings table (140), metadata mapping table (141) and conversion rules table (142). The software in block 207 then initializes data bots for each field in the metadata mapping table (141) that mapped to the basic financial system database (5) in accordance with the frequency specified by user (20) in the system settings table (140). Bots are independent components of the application that have specific tasks to perform. In the case of data acquisition bots, their tasks are to extract and convert data from a specified source and then store it in a specified location. Each data bot initialized by software block 207 will store its data in the basic financial system table (143). Every data acquisition bot for every data source contains the information shown in Table 17.

TABLE 17

| | |
|---|---|
| 1. | Unique ID number (based on date, hour, |
| | minute, second of creation) |
| 2. | The data source location |
| 3. | Mapping information |
| 4. | Timing of extraction |
| 5. | Conversion rules (if any) |
| 6. | Storage location (to allow for tracking of source |
| | and destination events) |
| 7. | Creation date (date, hour, minute, second) |

After the software in block 207 initializes all the bots for the basic financial system database, processing advances to a block 208. In block 208, the bots extract and convert data in accordance with their preprogrammed instructions in accordance with the frequency specified by user (20) in the system settings table (140). As each bot extracts and converts data from the basic financial system database (5), processing advances to a software block 209 before the bot completes data storage. The software in block 209 checks the basic financial system metadata to see if all fields have been extracted. If the software in block 209 finds no unmapped data fields, then the extracted, converted data is stored in the basic financial system table (143). Alternatively, if there are fields that haven't been extracted, then processing advances to a block 211. The software in block 211 prompts the user (20) via the metadata and conversion rules window (702) to provide metadata and conversion rules for each new field. The information regarding the new metadata and conversion rules is stored in the metadata mapping table (141) and conversion rules table (142) while the extracted, converted data is stored in the basic financial system table (143). It is worth noting at this point that the activation and operation of bots that don't have unmapped fields continues. Only bots with unmapped fields “wait” for user input before completing data storage. The new metadata and conversion rule information will be used the next time bots are initialized in accordance with the frequency established by the user (20). In either event, system processing passes on to software block 212.

The software in block 212 checks the system settings table (140) in the application database (50) to determine if the current calculation is a new calculation or a structure change. If the calculation is not a new calculation or a structure change then processing advances to a software block 228. Alternatively, if the calculation is new or a structure change, then processing advances to a software block 221.

The software in block 221 checks the bot date table (149) and deactivates any operation management system data bots with creation dates before the current system date and retrieves information from the system settings table (140), metadata mapping table (141) and conversion rules table (142). The software in block 221 then initializes data bots for each field in the metadata mapping table (141) that mapped to the operation management system database (10) in accordance with the frequency specified by user (20) in the system settings table (140). Each data bot initialized by software block 221 will store its data in the operation system table (144).

After the software in block 221 initializes all the bots for the operation management system database (10), processing advances to a block 222. In block 222, the bots extract and convert data in accordance with their preprogrammed instructions with the frequency specified by user (20) in the system settings table (140). As each bot extracts and converts data from the operation management system database (10), processing advances to a software block 209 before the bot completes data storage. The software in block 209 checks the operation management system metadata to see if all fields have been extracted. If the software in block 209 finds no unmapped data fields, then the extracted, converted data is stored in the operation system table (144). Alternatively, if there are fields that haven't been extracted, then processing advances to a block 211. The software in block 211 prompts the user (20) via the metadata and conversion rules window (702) to provide metadata and conversion rules for each new field. The information regarding the new metadata and conversion rules is stored in the metadata mapping table (141) and conversion rules table (142) while the extracted, converted data is stored in the operation system table (144). It is worth noting at this point that the activation and operation of bots that don't have unmapped fields continues. Only bots with unmapped fields “wait” for user input before completing data storage. The new metadata and conversion rule information will be used the next time bots are initialized in accordance with the frequency established by the user (20). In either event, system processing then passes on to a software block 225.

The software in block 225 checks the bot date table (149) and deactivates any web site transaction log data bots with creation dates before the current system date and retrieves information from the system settings table (140), metadata mapping table (141) and conversion rules table (142). The software in block 225 then initializes data bots for each field in the metadata mapping table (141) that mapped to the web site transaction log database (12) in accordance with the frequency specified by user (20) in the system settings table (140). Each data bot initialized by software block 225 will store its data in the web log data table (172).

After the software in block 225 initializes all the bots for the web site transaction log database (12), the bots extract and convert data in accordance with their preprogrammed instructions in accordance with the frequency specified by user (20) in the system settings table (140). As each bot extracts and converts data from the web site transaction log database (12), processing advances to a software block 209 before the bot completes data storage. The software in block 209 checks the web site transaction log metadata to see if all fields have been extracted. If the software in block 209 finds no unmapped data fields, then the extracted, converted data is stored in the web log data table (172). Alternatively, if there are fields that haven't been extracted, then processing advances to a block 211. The software in block 211 prompts the user (20) via the metadata and conversion rules window (702) to provide metadata and conversion rules for each new field. The information regarding the new metadata and conversion rules is stored in the metadata mapping table (141) and conversion rules table (142) while the extracted, converted data is stored in the web log data table (172). It is worth noting at this point that the activation and operation of bots that don't have unmapped fields continues. Only bots with unmapped fields “wait” for user input before completing data storage. The new metadata and conversion rule information will be used the next time bots are initialized in accordance with the frequency established by the user (20). In either event, system processing then passes on to a software block 226.

The software in block 226 checks the bot date table (149) and deactivates any human resource information system data bots with creation dates before the current system date and retrieves information from the system settings table (140), metadata mapping table (141) and conversion rules table (142). The software in block 226 then initializes data bots for each field in the metadata mapping table (141) that mapped to the human resource information system database (15) in accordance with the frequency specified by user (20) in the system settings table (140). Each data bot initialized by software block 226 will store its data in the human resource system table (145).

After the software in block 226 initializes all the bots for the human resource information system database, the bots extract and convert data in accordance with their preprogrammed instructions in accordance with the frequency specified by user (20) in the system settings table (140). As each bot extracts and converts data from the human resource information system database (15), processing advances to a software block 209 before the bot completes data storage. The software in block 209 checks the human resource information system metadata to see if all fields have been extracted. If the software in block 209 finds no unmapped data fields, then the extracted, converted data is stored in the human resource system table (145). Alternatively, if there are fields that haven't been extracted, then processing advances to a block 211. The software in block 211 prompts the user (20) via the metadata and conversion rules window (702) to provide metadata and conversion rules for each new field. The information regarding the new metadata and conversion rules is stored in the metadata mapping table (141) and conversion rules table (142) while the extracted, converted data is stored in the human resource system table (145). It is worth noting at this point that the activation and operation of bots that don't have unmapped fields continues. Only bots with unmapped fields “wait” for user input before completing data storage. The new metadata and conversion rule information will be used the next time bots are initialized in accordance with the frequency established by the user (20). In either event, system processing then passes on to software block 228.

The software in block 228 checks the system settings table (140) in the application database (50) to determine if the current calculation is a new calculation or a structure change. If the calculation is not a new calculation or a structure change then processing advances to a software block 248. Alternatively, if the calculation is new or a structure change, then processing advances to a software block 241.

The software in block 241 checks the bot date table (149) and deactivates any external database data bots with creation dates before the current system date and retrieves information from the system settings table (140), metadata mapping table (141) and conversion rules table (142). The software in block 241 then initializes data bots for each field in the metadata mapping table (141) that mapped to the external database (25) in accordance with the frequency specified by user (20) in the system settings table (140). Each data bot initialized by software block 241 will store its data in the external database table (146).

After the software in block 241 initializes all the bots for the external database, processing advances to a block 242. In block 242, the bots extract and convert data in accordance with their preprogrammed instructions. As each bot extracts and converts data from the external database (25), processing advances to a software block 209 before the bot completes data storage. The software in block 209 checks the external database metadata to see if all fields have been extracted. If the software in block 209 finds no unmapped data fields, then the extracted, converted data is stored in the external database table (146). Alternatively, if there are fields that haven't been extracted, then processing advances to a block 211. The software in block 211 prompts the user (20) via the metadata and conversion rules window (702) to provide metadata and conversion rules for each new field. The information regarding the new metadata and conversion rules is stored in the metadata mapping table (141) and conversion rules table (142) while the extracted, converted data is stored in the external database table (146). It is worth noting at this point that the activation and operation of bots that don't have unmapped fields continues. Only bots with unmapped fields “wait” for user input before completing data storage. The new metadata and conversion rule information will be used the next time bots are initialized in accordance with the frequency established by the user (20). In either event, system processing then passes on to a software block 245.

The software in block 245 checks the bot date table (149) and deactivates any advanced financial system data bots with creation dates before the current system date and retrieves information from the system settings table (140), metadata mapping table (141) and conversion rules table (142). The software in block 245 then initializes data bots for each field in the metadata mapping table (141) that mapped to the advanced financial system database (30) in accordance with the frequency specified by user (20) in the system settings table (140). Each data bot initialized by software block 245 will store its data in the advanced finance system table (147).

After the software in block 245 initializes all the bots for the advanced financial system database, the bots extract and convert data in accordance with their preprogrammed instructions in accordance with the frequency specified by user (20) in the system settings table (140). As each bot extracts and converts data from the advanced financial system database (30), processing advances to a software block 209 before the bot completes data storage. The software in block 209 checks the advanced financial system database metadata to see if all fields have been extracted. If the software in block 209 finds no unmapped data fields, then the extracted, converted data is stored in the advanced finance system table (147). Alternatively, if there are fields that haven't been extracted, then processing advances to a block 211. The software in block 211 prompts the user (20) via the metadata and conversion rules window (702) to provide metadata and conversion rules for each new field. The information regarding the new metadata and conversion rules is stored in the metadata mapping table (141) and conversion rules table (142) while the extracted, converted data is stored in the advanced finance system table (147). It is worth noting at this point that the activation and operation of bots that don't have unmapped fields continues. Only bots with unmapped fields “wait” for user input before completing data storage. The new metadata and conversion rule information will be used the next time bots are initialized in accordance with the frequency established by the user (20). In either event, system processing then passes on to software block 246.

The software in block 246 checks the bot date table (149) and deactivates any soft asset management system data bots with creation dates before the current system date and retrieves information from the system settings table (140), metadata mapping table (141) and conversion rules table (142). The software in block 246 then initializes data bots for each field in the metadata mapping table (141) that mapped to a soft asset management system database (35) in accordance with the frequency specified by user (20) in the system settings table (140). Extracting data from each soft asset management system ensures that the management of each soft asset is considered and prioritized within the overall financial models for each enterprise. Each data bot initialized by software block 246 will store its data in the soft asset system table (148).

After the software in block 246 initializes bots for all soft asset management system databases, the bots extract and convert data in accordance with their preprogrammed instructions in accordance with the frequency specified by user (20) in the system settings table (140). As each bot extracts and converts data from the soft asset management system database (35), processing advances to a software block 209 before the bot completes data storage. The software in block 209 checks the metadata for the soft asset management system databases to see if all fields have been extracted. If the software in block 209 finds no unmapped data fields, then the extracted, converted data is stored in the soft asset system table (148). Alternatively, if there are fields that haven't been extracted, then processing advances to a block 211. The software in block 211 prompts the user (20) via the metadata and conversion rules window (702) to provide metadata and conversion rules for each new field. The information regarding the new metadata and conversion rules is stored in the metadata mapping table (141) and conversion rules table (142) while the extracted, converted data is stored in the soft asset system table (148). It is worth noting at this point that the activation and operation of bots that don't have unmapped fields continues. Only bots with unmapped fields “wait” for user input before completing data storage. The new metadata and conversion rule information will be used the next time bots are initialized in accordance with the frequency established by the user (20). In either event, system processing then passes on to software block 248.

The software in block 248 checks the system settings table (140) in the application database (50) to determine if the current calculation is a new calculation or a structure change. If the calculation is not a new calculation or a structure change then processing advances to a software block 264. Alternatively, if the calculation is new or a structure change, then processing advances to a software block 261.

The software in block 261 checks the bot date table (149) and deactivates any supply chain system data bots with creation dates before the current system date and retrieves information from the system settings table (140), metadata mapping table (141) and conversion rules table (142). The software in block 261 then initializes data bots for each field in the metadata mapping table (141) that mapped to a supply chain system database (37) in accordance with the frequency specified by user (20) in the system settings table (140). Each data bot initialized by software block 261 will store its data in the supply chain system table (174).

After the software in block 261 initializes bots for all supply chain system databases, the bots extract and convert data in accordance with their preprogrammed instructions in accordance with the frequency specified by user (20) in the system settings table (140). As each bot extracts and converts data from the supply chain system databases (37), processing advances to a software block 209 before the bot completes data storage. The software in block 209 checks the metadata for the supply chain system database (37) to see if all fields have been extracted. If the software in block 209 finds no unmapped data fields, then the extracted, converted data is stored in the supply chain system table (174). Alternatively, if there are fields that haven't been extracted, then processing advances to a block 211. The software in block 211 prompts the user (20) via the metadata and conversion rules window (702) to provide metadata and conversion rules for each new field. The information regarding the new metadata and conversion rules is stored in the metadata mapping table (141) and conversion rules table (142) while the extracted, converted data is stored in the supply chain system table (174). It is worth noting at this point that the activation and operation of bots that don't have unmapped fields continues. Only bots with unmapped fields “wait” for user input before completing data storage. The new metadata and conversion rule information will be used the next time bots are initialized in accordance with the frequency established by the user (20). In either event, system processing then passes on to software block 264.

The software in block 264 checks the system settings table (140) in the application database (50) to determine if the current calculation is a new calculation or a structure change. If the calculation is not a new calculation or a structure change then processing advances to a software block 276. Alternatively, if the calculation is new or a structure change, then processing advances to a software block 265.

The software in block 265 prompts the user (20) via the identification and classification rules window (703) to identify keywords such as company names, brands, trademarks, competitors for pre-specified fields in the metadata mapping table (141). The user (20) also has the option of mapping keywords to other fields in the metadata mapping table (141). After specifying the keywords, the user (20) is prompted to select and classify descriptive terms for each keyword. The input from the user (20) is stored in the keyword table (150) in the application database before processing advances to a software block 266.

The software in block 266 checks the bot date table (149) and deactivates any internet text and linkage bots with creation dates before the current system date and retrieves information from the system settings table (140), the metadata mapping table (141) and the keyword table (150). The software in block 266 then initializes internet text and linkage bots for each field in the metadata mapping table (141) that mapped to a keyword in accordance with the frequency specified by user (20) in the system settings table (140). Bots are independent components of the application that have specific tasks to perform. In the case of text and linkage bots, their tasks are to locate, count and classify keyword matches and linkages from a specified source and then store their findings in a specified location. Each text and linkage bot initialized by software block 266 will store the location, count and classification data it discovers in the classified text table (151). Multimedia data can be processed using bots with essentially the same specifications if software to translate and parse the multimedia content is included in each bot. Every internet text and linkage bot contains the information shown in Table 18.

TABLE 18

| | |
|---|---|
| 1. | Unique ID number (based on date, hour, |
| | minute, second of creation) |
| 2. | Creation date (date, hour, minute, second) |
| 3. | Storage location |
| 4. | Mapping information |
| 5. | Home URL |
| 6. | Keyword |
| 7. | Descriptive term 1 |

To

| | |
|---|---|
| 7 + n. | Descriptive term n |

Once activated, the text and linkage bots locate and classify data from the internet (40) in accordance with their programmed instructions in accordance with the frequency specified by user (20) in the system settings table (140). As each text and linkage bot locates and classifies data from the internet (40) processing advances to a software block 268 before the bot completes data storage. The software in block 268 checks to see if all linkages are identified and all keyword hits are associated with descriptive terms that have been been classified. If the software in block 268 doesn't find any unclassified “hits” or “links”, then the address, counts and classified text are stored in the classified text table (151). Alternatively, if there are terms that haven't been classified or links that haven't been identified, then processing advances to a block 269. The software in block 269 prompts the user (20) via the identification and classification rules window (703) to provide classification rules for each new term. The information regarding the new classification rules is stored in the keyword table (150) while the newly classified text and linkages are stored in the classified text table (151). It is worth noting at this point that the activation and operation of bots that don't have unclassified fields continues. Only bots with unclassified fields will “wait” for user input before completing data storage. The new classification rules will be used the next time bots are initialized in accordance with the frequency established by the user (20). In either event, system processing then passes on to a software block 270.

The software in block 270 checks the bot date table (149) and deactivates any external database bots with creation dates before the current system date and retrieves information from the system settings table (140), the metadata mapping table (141) and the keyword table (150). The software in block 270 then initializes external database bots for each field in the metadata mapping table (141) that mapped to a keyword in accordance with the frequency specified by user (20) in the system settings table (140). Every bot initialized by software block 270 will store the location, count and classification of data it discovers in the classified text table (151). Every external database bot contains the information shown in Table 19.

TABLE 19

| | |
|---|---|
| 1. | Unique ID number (based on date, hour, |
| | minute, second of creation) |
| 2. | Creation date (date, hour, minute, second) |
| 3. | Storage location |
| 4. | Mapping information |
| 5. | Data source |
| 6. | Keyword |
| 7. | Storage location |
| 8. | Descriptive term 1 |

To

| | |
|---|---|
| 8 + n. | Descriptive term n |

Once activated, the bots locate data from the external database (25) in accordance with its programmed instructions with the frequency specified by user (20) in the system settings table (140). As each bot locates and classifies data from the external database (25) processing advances to a software block 268 before the bot completes data storage. The software in block 268 checks to see if all keyword hits are associated with descriptive terms that have been classified. If the software in block 268 doesn't find any unclassified “hits”, then the address, count and classified text are stored in the classified text table (151) or the external database table (146) as appropriate. Alternatively, if there are terms that haven't been classified, then processing advances to a block 269. The software in block 269 prompts the user (20) via the identification and classification rules window (703) to provide classification rules for each new term. The information regarding the new classification rules is stored in the keyword table (150) while the newly classified text is stored in the classified text table (151). It is worth noting at this point that the activation and operation of bots that don't have unclassified fields continues. Only bots with unclassified fields “wait” for user input before completing data storage. The new classification rules will be used the next time bots are initialized in accordance with the frequency established by the user (20). In either event, system processing then passes on to software block 276.

The software in block 276 checks the system settings table (140) in the application database (50) to determine if the current calculation is a new calculation or a structure change. If the calculation is not a new calculation or a structure change then processing advances to a software block 291. Alternatively, if the calculation is new or a structure change, then processing advances to a software block 277.

The software in block 277 checks the system settings table (140) to see if there is geocoded data in the application database (50) and to determine which on-line geocoding service (Centrus™ from QM Soft or MapMarker™ from Maplnfo) is being used. If geospatial data is not being used, then processing advances to a block 291. Alternatively, if the software in block 277 determines that geospatial data are being used, processing advances to a software block 278.

The software in block 278 prompts the user (20) via the geospatial measure definitions window (709) to define the measures that will be used in evaluating the elements of value. After specifying the measures, the user (20) is prompted to select the geospatial locus for each measure from the data already stored in the application database (50). The input from the user (20) is stored in the geospatial measures table (152) in the application database before processing advances to a software block 279.

The software in block 279 checks the bot date table (149) and deactivates any geospatial bots with creation dates before the current system date and retrieves information from the system settings table (140), the metadata mapping table (141) and the geospatial measures table (152). The software in block 279 then initializes geospatial bots for each field in the metadata mapping table (141) that mapped to geospatial data in the application database (50) in accordance with the frequency specified by user (20) in the system settings table (140) before advancing processing to a software block 280.

Bots are independent components of the application that have specific tasks to perform. In the case of geospatial bots, their tasks are to calculate user specified measures using a specified geocoding service and then store the measures in a specified location. Each geospatial bot initialized by software block 279 will store the measures it calculates in the application database table where the geospatial data was found. Tables that could include geospatial data include: the basic financial system table (143), the operation system table (144), the human resource system table (145), the external database table (146), the advanced finance system table (147) and the soft asset system table (148). Every geospatial bot contains the information shown in Table 20.

TABLE 20

| | |
|---|---|
| 1. | Unique ID number (based on date, hour, |
| | minute, second of creation) |
| 2. | Creation date (date, hour, minute, second) |
| 3. | Mapping information |
| 4. | Storage location |
| 5. | Geospatial locus |
| 6. | Geospatial measure |
| 7. | Geocoding service |

In block 280 the geospatial bots locate data and complete measurements in accordance with their programmed instructions with the frequency specified by the user (20) in the system settings table (140). As each geospatial bot retrieves data and calculates the geospatial measures that have been specified, processing advances to a block 281 before the bot completes data storage. The software in block 281 checks to see if all geospatial data located by the bot has been measured. If the software in block 281 doesn't find any unmeasured data, then the measurement is stored in the application database (50). Alternatively, if there are data elements that haven't been measured, then processing advances to a block 282. The software in block 282 prompts the user (20) via the geospatial measures definition window (709) to provide measurement rules for each new term. The information regarding the new measurement rules is stored in the geospatial measures table (152) while the newly calculated measurement is stored in the appropriate table in the application database (50). It is worth noting at this point that the activation and operation of bots that don't have unmeasured fields continues. Only the bots with unmeasured fields “wait” for user input before completing data storage. The new measurement rules will be used the next time bots are initialized in accordance with the frequency established by the user (20). In either event, system processing then passes on to a software block 291.

The software in block 291 checks: the basic financial system table (143), the operation system table (144), the human resource system table (145), the external database table (146), the advanced finance system table (147), the soft asset system table (148), the classified text table (151) and the geospatial measures table (152) to see if data are missing from any of the periods required for system calculation. The range of required dates was previously calculated by the software in block 202. If there are no data missing from any period, then processing advances to a software block 293. Alternatively, if there are missing data for any field for any period, then processing advances to a block 292.

The software in block 292, prompts the user (20) via the missing data window (704) to specify the method to be used for filling the blanks for each item that is missing data. Options the user (20) can choose for filling the blanks include: the average value for the item over the entire time period, the average value for the item over a specified period, zero, the average of the preceding item and the following item values and direct user input for each missing item. If the user (20) doesn't provide input within a specified interval, then the default missing data procedure specified in the system settings table (140) is used. When all the blanks have been filled and stored for all of the missing data, system processing advances to a block 293.

The software in block 293 calculates attributes by item for each numeric data field in the basic financial system table (143), the operation system table (144), the human resource system table (145), the external database table (146), the advanced finance system table (147) and the soft asset system table (148). The attributes calculated in this step include: cumulative total value, the period-to-period rate of change in value, the rolling average value and a series of time lagged values. In a similar fashion the software in block 293 calculates attributes for each date field in the specified tables including time since last occurrence, cumulative time since first occurrence, average frequency of occurrence and the rolling average frequency of occurrence. The numbers derived from numeric and date fields are collectively referred to as “item performance indicators”. The software in block 293 also calculates pre-specified combinations of variables called composite variables for measuring the strength of the different elements of value. The item performance indicators are stored in the table where the item source data was obtained and the composite variables are stored in the composite variables table (153) before processing advances to a block 294.

The software in block 294 uses attribute derivation algorithms such as the AQ program to create combinations of the variables that weren't pre-specified for combination. While the AQ program is used in one embodiment of the present invention, other attribute derivation algorithms such as the LINUS algorithms, may be used to the same effect. The software creates these attributes using both item variables that were specified as “element” variables and item variables that were not. The resulting composite variables are stored in the composite variables table (153) before processing advances to a block 295.

The software in block 295 derives market value factors by enterprise for each numeric data field with data in the sentiment factor table (169). Market value factors include: the ratio of enterprise earnings to expected earnings, inflation rate, growth in g.d.p., volatility, volatility vs. industry average volatility, interest rates, increases in interest rates, consumer confidence and the unemployment rate that have an impact on the market price of the equity for an enterprise and/or an industry. The market value factors derived in this step include: cumulative totals, the period to period rate of change, the rolling average value and a series of time lagged values. In a similar fashion the software in block 295 calculates market value factors for each date field in the specified table including time since last occurrence, cumulative time since first occurrence, average frequency of occurrence and the rolling average frequency of occurrence. The numbers derived from numeric and date fields are collectively referred to as “market performance indicators”. The software in block 295 also calculates pre-specified combinations of variables called composite factors for measuring the strength of the different market value factors. The market performance indicators and the composite factors are stored in the sentiment factor table (169) before processing advances to a block 296.

The software in block 296 uses attribute derivation algorithms such as the Linus algorithm to create combinations of the factors that were not pre-specified for combination. While the Linus algorithm is used in one embodiment of the present invention, other attribute derivation algorithms such as the AQ program may be used to the same effect. The software creates these attributes using both market value factors that were included in “composite factors” and market value factors that were not. The resulting composite variables are stored in the sentiment factors table (169) before processing advances to a block 297.

The software in block 297 uses pattern-matching algorithms to assign pre-designated data fields for different elements of value to pre-defined groups with numerical values. This type of analysis is useful in classifying purchasing patterns and/or communications patterns as “heavy”, “light”, “moderate” or “sporadic”. The classification and the numeric value associated with the classification are stored in the application database (50) table where the data field is located before processing advances to a block 298.

The software in block 298 retrieves data from the metadata mapping table (141), creates and then stores the definitions for the pre-defined components of value in the components of value definition table (155). As discussed previously, the revenue component of value is not divided into sub-components, the expense value is divided into five sub-components (the cost of raw materials, the cost of manufacture or delivery of service, the cost of selling, the cost of support and the cost of administration) and the capital value is divided into six sub-components: (cash, non-cash financial assets, production equipment, other assets, financial liabilities and equity) in one embodiment. Different subdivisions of the components of value can be used to the same effect. When data storage is complete, processing advances to a software block 302 to begin the analysis of the extracted data using analysis bots.

### Analysis Bots

The flow diagrams in FIG. 6A, FIG. 6B and FIG. 6C detail the processing that is completed by the portion of the application software (300) that programs analysis bots to determine the value contribution of each element of value and sub-element of value to enterprise value by category of value. Each analysis bot generally normalizes the data being analyzed before processing begins.

Processing in this portion of the application begins in software block 302. The software in block 302 checks the system settings table (140) in the application database (50) to determine if the current calculation is a new calculation or a structure change. If the calculation is not a new calculation or a structure change then processing advances to a software block 323. Alternatively, if the calculation is new or a structure change, then processing advances to a software block 303.

The software in block 303 retrieves data from the meta data mapping table (141) and the soft asset system table (148) and then assigns item variables, item performance indicators and composite variables to each element of value using a two step process. First, item variables and item performance indicators are assigned to elements of value based on the soft asset management system they correspond to (for example, all item variables from a brand management system and all item performance indicators derived from brand management system variables are assigned to the brand element of value). Second, pre-defined composite variables are assigned to the element of value they were assigned to measure in the metadata mapping table (141). After the assignment of variables and indicators to elements of value is complete, the resulting assignments are saved to the element of value definition table (155) and processing advances to a block 304.

The software in block 304 checks the bot date table (149) and deactivates any temporal clustering bots with creation dates before the current system date. The software in block 304 then initializes bots as required for each component of value. The bots activate in accordance with the frequency specified by the user (20) in the system settings table (140), retrieve the information from the system settings table (140), the metadata mapping table (141) and the component of value definition table (156) as required and define segments for the component of value data before saving the resulting cluster information in the application database (50).

Bots are independent components of the application that have specific tasks to perform. In the case of temporal clustering bots, their primary task is to segment the component and sub-component of value variables into distinct time regimes that share similar characteristics. The temporal clustering bot assigns a unique id number to each “regime” it identifies and stores the unique id numbers in the cluster id table (157). Every time period with data is assigned to one of the regimes. The cluster id for each regime is saved in the data record for each item variable in the table where it resides. The item variables are segmented into a number of regimes less than or equal to the maximum specified by the user (20) in the system settings. The data are segmented using a competitive regression algorithm that identifies an overall, global model before splitting the data and creating new models for the data in each partition. If the error from the two models is greater than the error from the global model, then there is only one regime in the data. Alternatively, if the two models produce lower error than the global model, then a third model is created. If the error from three models is lower than from two models then a fourth model is added. The process continues until adding a new model does not improve accuracy. Other temporal clustering algorithms may be used to the same effect. Every temporal clustering bot contains the information shown in Table 21.

TABLE 21

| | |
|---|---|
| 1. | Unique ID number (based on date, |
| | hour, minute, second of creation) |
| 2. | Creation date (date, hour, minute, second) |
| 3. | Mapping information |
| 4. | Storage location |
| 5. | Maximum number of clusters |
| 6. | Variable 1 |

. . . to

| | |
|---|---|
| 6 + n. | Variable n |

When bots in block 304 have identified and stored regime assignments for all time periods with data, processing advances to a software block 305.

The software in block 305 checks the bot date table (149) and deactivates any variable clustering bots with creation dates before the current system date. The software in block 305 then initializes bots as required for each element of value. The bots activate in accordance with the frequency specified by the user (20) in the system settings table (140), retrieve the information from the system settings table (140), the metadata mapping table (141) and the element of value definition table (155) as required and define segments for the element of value data before saving the resulting cluster information in the application database (50).

Bots are independent components of the application that have specific tasks to perform. In the case of variable clustering bots, their primary task is to segment the element of value variables into distinct clusters that share similar characteristics. The clustering bot assigns a unique id number to each “cluster” it identifies and stores the unique id numbers in the cluster id table (157). Every item variable for every element of value is assigned to one of the unique clusters. The cluster id for each variable is saved in the data record for each item variable in the table where it resides. The item variables are segmented into a number of clusters less than or equal to the maximum specified by the user (20) in the system settings. The data are segmented using the “default” clustering algorithm the user (20) specified in the system settings. The system of the present invention provides the user (20) with the choice of several clustering algorithms including: an unsupervised “Kohonen” neural network, neural network, decision tree, support vector method, K-nearest neighbor, expectation maximization (EM) and the segmental K-means algorithm. For algorithms that normally require the number of clusters to be specified, the bot will iterate the number of clusters until it finds the cleanest segmentation for the data. Every variable clustering bot contains the information shown in Table 22.

TABLE 22

| | |
|---|---|
| 1. | Unique ID number (based on date, hour, minute, second of |
| | creation) |
| 2. | Creation date (date, hour, minute, second) |
| 3. | Mapping information |
| 4. | Storage location |
| 5. | Element of value |
| 6. | Clustering algorithm type |
| 7. | Maximum number of clusters |
| 8. | Variable 1 |
| . . . | to |
| 8 + n. | Variable n |

When bots in block 305 have identified and stored cluster assignments for the item variables associated with each component and subcomponent of value, processing advances to a software block 306.

The software in block 306 checks the bot date table (149) and deactivates any predictive model bots with creation dates before the current system date. The software in block 306 then retrieves the information from the system settings table (140), the metadata mapping table (141), the element of value definition table (155) and the component of value definition table (156) required to initialize predictive model bots for each component of value.

Bots are independent components of the application that have specific tasks to perform. In the case of predictive model bots, their primary task is to determine the relationship between the item variables, item performance indicators and composite variables (collectively hereinafter, “the variables”) and the components of value (and sub-components of value). Predictive model bots are initialized for each component and sub-component of value. They are also initialized for each cluster and regime of data in accordance with the cluster and regime assignments specified by the bots in blocks 304 and 305. A series of predictive model bots are initialized at this stage because it is impossible to know in advance which predictive model type will produce the “best” predictive model for the data from each commercial enterprise. The series for each model includes 12 predictive model bot types: neural network; CART; GARCH, projection pursuit regression; generalized additive model (GAM); redundant regression network; rough-set analysis; boosted Naive Bayes Regression; MARS; linear regression; support vector method and stepwise regression. Additional predictive model types can be used to the same effect. The software in block 306 generates this series of predictive model bots for the levels of the enterprise shown in Table 23.

TABLE 23
Predictive models by enterprise level

Enterprise:
Element variables relationship to enterprise revenue component of value
Element variables relationship to enterprise expense subcomponents of
value Element
variables relationship to enterprise capital change subcomponents of value
Element of Value:
Sub-element of value variables relationship to element of value

Every predictive model bot contains the information shown in Table 24.

TABLE 24

| | |
|---|---|
| 1. | Unique ID number (based on date, hour, minute, |
| | second of creation) |
| 2. | Creation date (date, hour, minute, second) |
| 3. | Mapping information |
| 4. | Storage location |
| 5. | Component or subcomponent of value |
| 6. | Global or Cluster (ID) and/or Regime (ID) |
| 7. | Element of value or Sub-Element of value ID |
| 8. | Predictive Model Type |
| 9. | Variable 1 |
| . . . | to |
| 9 + n. | Variable n |

After predictive model bots are initialized, the bots activate in accordance with the frequency specified by the user (20) in the system settings table (140). Once activated, the bots retrieve the required data from the appropriate table in the application database (50) and randomly partition the item variables, item performance indicators and composite variables into a training set and a test set. The software in block 306 uses “bootstrapping” where the different training data sets are created by re-sampling with replacement from the original training set, so data records may occur more than once. The same sets of data will be used to train and then test each predictive model bot. When the predictive model bots complete their training and testing, processing advances to a block 307.

The software in block 307 determines if clustering improved the accuracy of the predictive models generated by the bots in software block 306. The software in block 307 uses a variable selection algorithm such as stepwise regression (other types of variable selection algorithms can be used) to combine the results from the predictive model bot analyses for each type of analysis—with and without clustering—to determine the best set of variables for each type of analysis. The type of analysis having the smallest amount of error as measured by applying the mean squared error algorithm to the test data is given preference in determining the best set of variables for use in later analysis. There are four possible outcomes from this analysis as shown in Table 25.

TABLE 25

1. Best model has no clustering
2. Best model has temporal clustering, no variable clustering
3. Best model has variable clustering, no temporal clustering
4. Best model has temporal clustering and variable clustering

If the software in block 307 determines that clustering improves the accuracy of the predictive models, then processing advances to a software block 310. Alternatively, if clustering doesn't improve the overall accuracy of the predictive models, then processing advances to a software block 308.

The software in block 308 uses a variable selection algorithm such as stepwise regression (other types of variable selection algorithms can be used) to combine the results from the predictive model bot analyses for each model to determine the best set of variables for each model. The models having the smallest amount of error as measured by applying the mean squared error algorithm to the test data are given preference in determining the best set of variables. As a result of this processing, the best set of variables contain: the item variables, item performance indicators and composite variables that correlate most strongly with changes in the components of value. The best set of variables will hereinafter be referred to as the “value drivers”. Eliminating low correlation factors from the initial configuration of the vector creation algorithms increases the efficiency of the next stage of system processing. Other error algorithms alone or in combination may be substituted for the mean squared error algorithm. After the best set of variables have been selected and stored in the element variables table (158) for all models at all levels, the software in block 308 tests the independence of the value drivers at the enterprise, element of value and sub-element of value level before processing advances to a block 309.

The software in block 309 checks the bot date table (149) and deactivates any causal model bots with creation dates before the current system date. The software in block 309 then retrieves the information from the system settings table (140), the metadata mapping table (141), the component of value definition table (156) and the element variables table (158) as required to initialize causal model bots for each enterprise, element of value and sub-element of value in accordance with the frequency specified by the user (20) in the system settings table (140).

Bots are independent components of the application that. have specific tasks to perform. In the case of causal model bots, their primary task is to refine the item variable, item performance indicator and composite variable selection to reflect only causal variables. (Note: these variables are grouped together to represent an element vector when they are dependent). A series of causal model bots are initialized at this stage because it is impossible to know in advance which causal model will produce the “best” vector for the best fit variables from each model. The series for each model includes five causal model bot types: Tetrad, MML, LaGrange, Bayesian and path analysis. The software in block 309 generates this series of causal model bots for each set of variables stored in the element variables table (158) in the previous stage in processing. Every causal model bot activated in this block contains the information shown in Table 26.

TABLE 26
1. Unique ID number (based on date, hour, minute, second of creation)
2. Creation date (date, hour, minute, second)
3. Mapping information
4. Storage location
5. Component or subcomponent of value
6. Enterprise, Element of value or Sub-Element of value ID
7. Variable Set
8. Causal model type

After the causal model bots are initialized by the software in block 309, the bots activate in accordance with the frequency specified by the user (20) in the system settings table (140). Once activated, they retrieve the element variable information for each model from the element variables table (158) and sub-divides the variables into two sets, one for training and one for testing. The same set of training data is used by each of the different types of bots for each model. After the causal model bots complete their processing for each model, the software in block 309 uses a model selection algorithm to identify the model that best fits the data for each enterprise, element of value or sub-element of value being analyzed. For the system of the present invention, a cross validation algorithm is used for model selection. The software in block 309 saves the best fit causal factors in the vector table (159) in the application database (50) and processing advances to a block 312. The software in block 312 tests the value drivers or vectors to see if there are “missing” value drivers that are influencing the results. If the software in block 312 does not detect any missing value drivers, then system processing advances to a block 323. Alternatively, if missing value drivers are detected by the software in block 312, then processing advances to a software block 321.

If software in block 307 determines that clustering improves predictive model accuracy, then processing advances to block 310 as described previously. The software in block 310 uses a variable selection algorithm such as stepwise regression (other types of variable selection algorithms can be used) to combine the results from the predictive model bot analyses for each model and cluster to determine the best set of variables for each model. The models having the smallest amount of error as measured by applying the mean squared error algorithm to the test data are given preference in determining the best set of variables. As a result of this processing, the best set of variables contain: the item variables, item performance indicators and composite variables that correlate most strongly with changes in the components of value. The best set of variables will hereinafter be referred to as the “value drivers”. Eliminating low correlation factors from the initial configuration of the vector creation algorithms increases the efficiency of the next stage of system processing. Other error algorithms alone or in combination may be substituted for the mean squared error algorithm. After the best set of variables have been selected and stored in the element variables table (158) for all models at all levels, the software in block 310 tests the independence of the value drivers at the enterprise, element of value and sub-element of value level before processing advances to a block 311.

The software in block 311 checks the bot date table (149) and deactivates any causal model bots with creation dates before the current system date. The software in block 311 then retrieves the information from the system settings table (140), the metadata mapping table (141), the component of value definition table (156) and the element variables table (158) as required to initialize causal model bots for each enterprise, element of value and sub-element of value at every level in accordance with the frequency specified by the user (20) in the system settings table (140).

Bots are independent components of the application that have specific tasks to perform. In the case of causal model bots, their primary task is to refine the item variable, item performance indicator and composite variable selection to reflect only causal variables. (Note: these variables are grouped together to represent a single element vector when they are dependent). In some cases it may be possible to skip the correlation step before selecting causal the item variable, item performance indicator and composite variables. A series of causal model bots are initialized at this stage because it is impossible to know in advance which causal model will produce the “best” vector for the best fit variables from each model. The series for each model includes four causal model bot types: Tetrad, LaGrange, Bayesian and path analysis. The software in block 311 generates this series of causal model bots for each set of variables stored in the element variables table (158) in the previous stage in processing. Every causal model bot activated in this block contains the information shown in Table 27.

TABLE 27
1. Unique ID number (based on date, hour, minute, second of creation)
2. Creation date (date, hour, minute, second)
3. Mapping information
4. Storage location
5. Component or subcomponent of value
6. Cluster (ID) and/or Regime (ID)
7. Element of value or Sub-Element of value ID
8. Variable set
9. Causal model type

After the causal model bots are initialized by the software in block 311, the bots activate in accordance with the frequency specified by the user (20) in the system settings table (140). Once activated, they retrieve the element variable information for each model from the element variables table (158) and sub-divides the variables into two sets, one for training and one for testing. The same set of training data is used by each of the different types of bots for each model. After the causal model bots complete their processing for each model, the software in block 311 uses a model selection algorithm to identify the model that best fits the data for each enterprise, element of value or sub-element of value being analyzed. For the system of the present invention, a cross validation algorithm is used for model selection. The software in block 311 saves the best fit causal factors in the vector table (159) in the application database (50) and processing advances to a block 312. The software in block 312 tests the value drivers or vectors to see if there are “missing” value drivers that are influencing the results. If the software in block 312 doesn't detect any missing value drivers, then system processing advances to a block 323. Alternatively, if missing value drivers are detected by the software in block 312, then processing advances to a software block 321.

The software in block 321 prompts the user (20) via the variable identification window (710) to adjust the specification(s) for the affected enterprise, element of value or subelement of value. After the input from the user (20) is saved in the system settings table (140) and/or the element of value definition table (155), system processing advances to a software block 323. The software in block 323 checks the system settings table (140) and/or the element of value definition table (155) to see if there any changes in structure. If there have been changes in the structure, then processing advances to a block 205 and the system processing described previously is repeated. Alternatively, if there are no changes in structure, then processing advances to a block 325.

The software in block 325 checks the system settings table (140) in the application database (50) to determine if the current calculation is a new one. If the calculation is new or a structure change, then processing advances to a software block 333. Alternatively, if the calculation is not a new calculation, then processing advances to a software block 326.

The software in block 326 checks the bot date table (149) and deactivates any vector generation bots with creation dates before the current system date. The software in block 326 then initializes bots for each element of value and sub-element of value for the enterprise. The bots activate in accordance with the frequency specified by the user (20) in the system settings table (140), retrieve the information from the system settings table (140), the metadata mapping table (141) the component of value definition table (156) and the element variables table (158) as required to initialize vector generation bots for each enterprise, element of value and sub-element of value in accordance with the frequency specified by the user (20) in the system settings table (140).

Bots are independent components of the application that have specific tasks to perform. In the case of vector generation bots, their primary task is to produce formulas, (hereinafter, vectors) that summarize the relationship between the item variables, item performance indicators and composite variables for the element of value or sub-element of value and changes in the component or sub-component of value being examined. (Note: these variables are simply grouped together to represent an element vector when they are dependent). A series of vector generation bots are initialized at this stage because it is impossible to know in advance which vector generation algorithm will produce the “best” vector for the best fit variables from each model. The series for each model includes three vector generation bot types: data fusion, polynomial and LaGrange. The software in block 326 generates this series of vector generation bots for each set of variables stored in the element variables table (158). Every vector generation bot contains the information shown in Table 28.

TABLE 28

| | |
|---|---|
| 1. | Unique ID number (based on date, hour, minute, second of |
| | creation) |
| 2. | Creation date (date, hour, minute, second) |
| 3. | Mapping information |
| 4. | Storage location |
| 5. | Maximum number of regimes |
| 6. | Enterprise or Industry |
| 7. | Factor 1 |
| . . . | to |
| 7 + n. | Factor n |

When bots in block 326 have identified and stored vectors for all time periods with data, processing advances to a software block 327.

The software in block 327 checks the bot date table (149) and deactivates any temporal clustering bots with creation dates before the current system date. The software in block 327 then initializes bots for market value factors for each enterprise with a market price and for the industry. The bots activate in accordance with the frequency specified by the user (20) in the system settings table (140), retrieve the information from the system settings table (140), the metadata mapping table (141) and the sentiment factor table (169) as required and define regimes for the market value factor data before saving the resulting regime information in the application database (50).

Bots are independent components of the application that have specific tasks to perform. In the case of temporal clustering bots for market value factors, their primary tasks are to identify the best market value indicator, price, relative price, yield or first derivative of price change to use for market factor analysis and then to segment the market value factors into distinct time regimes that share similar characteristics. The temporal clustering bots select the best value indicator by grouping the universe of stocks using each of the four value indicators and then comparing the clusters to the known groupings of the S&P 500. The temporal clustering bots then use the identified value indicator in the analysis of temporal clustering. The bots assign a unique id number to each “regime” it identifies and stores the unique id numbers in the cluster id table (157) every time period with data is assigned to one of the regimes. The cluster id for each regime is also saved in the data record for each market value factor in the table where it resides. The market value factors are segmented into a number of regimes less than or equal to the maximum specified by the user (20) in the system settings. The factors are segmented using a competitive regression algorithm that identifies an overall, global model before splitting the data and creating new models for the data in each partition. If the error from the two models is greater than the error from the global model, then there is only one regime in the data. Alternatively, if the two models produce lower error than the global model, then a third model is created. If the error from three models is lower than from two models then a fourth model is added. The process continues until adding a new model does not improve accuracy. Other temporal clustering algorithms may be used to the same effect. Every temporal clustering bot contains the information shown in Table 29.

TABLE 29

| | |
|---|---|
| 1. | Unique ID number (based on date, hour, minute, second of |
| | creation) |
| 2. | Creation date (date, hour, minute, second) |
| 3. | Mapping information |
| 4. | Storage location |
| 5. | Maximum number of regimes |
| 6. | Enterprise or Industry |
| 7. | Value indicator (price, relative price, yield, derivative, etc.) |
| 8. | Factor 1 |
| . . . | to |
| 8 + n. | Factor n |

When bots in block 327 have identified and stored regime assignments for all time periods with data, processing advances to a software block 328.

The software in block 328 checks the bot date table (149) and deactivates any causal factor bots with creation dates before the current system date. The software in block 328 then retrieves the information from the system settings table (140), the metadata mapping table (141), the element of value definition table (155) and the sentiment factors table (169) as required to initialize causal market value factor bots for the enterprise and for the industry in accordance with the frequency specified by the user (20) in the system settings table (140).

Bots are independent components of the application that have specific tasks to perform. In the case of causal factor bots, their primary task is to identify the item variables, item performance indicators, composite variables and market value factors that are causal factors for stock price movement. (Note: these variables are grouped together when they are dependent). For each enterprise and industry the causal factors are those that drive changes in the value indicator identified by the temporal clustering bots. A series of causal factor bots are initialized at this stage because it is impossible to know in advance which causal factors will produce the “best” model for each enterprise and industry. The series for each model includes five causal model bot types: Tetrad, LaGrange, MML, Bayesian and path analysis. Other causal models can be used to the same effect. The software in block 328 generates this series of causal model bots for each set of variables stored in the element variables table (158) in the previous stage in processing. Every causal factor bot activated in this block contains the information shown in Table 30.

TABLE 30
1. Unique ID number (based on date, hour, minute, second of creation)
2. Creation date (date, hour, minute, second)
3. Mapping information
4. Storage location
6. Enterprise or Industry
7. Regime
8. Value indicator (price, relative price, yield, derivative, etc.)
9. Causal model type

After the causal factor bots are initialized by the software in block 328, the bots activate in accordance with the frequency specified by the user (20) in the system settings table (140). Once activated, they retrieve the required information from the element of value definition table (155) and the sentiment factor table (169) and sub-divide the data into two sets, one for training and one for testing. The same set of training data is used by each of the different types of bots for each model. After the causal factor bots complete their processing for the enterprise and/or industry, the software in block 328 uses a model selection algorithm to identify the model that best fits the data for each enterprise or industry. For the system of the present invention, a cross validation algorithm is used for model selection. The software in block 328 saves the best fit causal factors in the sentiment factors table (169) in the application database (50) and processing advances to a block 329. The software in block 329 tests to see if there are “missing” causal market value factors that are influencing the results. If the software in block 329 does not detect any missing market value factors, then system processing advances to a block 330. Alternatively, if missing market value factors are detected by the software in block 329, then processing returns to software block 321 and the processing described in the preceding section is repeated.

The software in block 330 checks the bot date table (149) and deactivates any industry rank bots with creation dates before the current system date. The software in block 330 then retrieves the information from the system settings table (140), the metadata mapping table (141), the vector table (159) and the sentiment factors table (169) as required to initialize industry rank bots for the enterprise if it has a public stock market price and for the industry in accordance with the frequency specified by the user (20) in the system settings table (140).

Bots are independent components of the application that have specific tasks to perform. In the case of industry rank bots, their primary task is to determine the relative position of the enterprise being evaluated on the causal attributes identified in the previous processing step. (Note: these variables are grouped together when they are dependent). The industry rank bots use Data Envelopement Analysis (hereinafter, DEA) to determine the relative industry ranking of the enterprise being examined. The software in block 330 generates industry rank bots for the enterprise being evaluated. Every industry rank bot activated in this block contains the information shown in Table 31.

TABLE 31
1. Unique ID number (based on date, hour, minute, second of creation)
2. Creation date (date, hour, minute, second)
3. Mapping information
4. Storage location
5. Enterprise

After the industry rank bots are initialized by the software in block 330, the bots activate in accordance with the frequency specified by the user (20) in the system settings table (140). Once activated, they retrieve the item variables, item performance indicators, composite variables and market value factors for the enterprise from the application database (50) and sub-divides the factors into two sets, one for training and one for testing. After the industry rank bots complete their processing for the enterprise the software in block 330 saves the industry ranks in the vector table (159) in the application database (50) and processing advances to a block 331.

The software in block 331 checks the bot date table (149) and deactivates any option bots with creation dates before the current system date. The software in block 331 then retrieves the information from the system settings table (140), the metadata mapping table (141), the basic financial system database (143), the external database table (146) and the advanced finance system table (147) as required to initialize option bots for the industry and the enterprise.

Bots are independent components of the application that have specific tasks to perform. In the case of option bots, their primary tasks are to calculate the discount rate to be used for valuing the real options and to value the real options for the industry and the enterprise. The discount rate for enterprise real options is calculated by adding risk factors for each causal soft asset to a base discount rate. The risk factor for each causal soft asset is determined by a two step process. The first step in the process divides the maximum real option discount rate (specified by the user in system settings) by the number of causal soft assets. The second step in the process determines if the enterprise is highly rated on the causal soft assets and also determines an appropriate risk factor. If the enterprise is highly ranked on the soft asset, then the discount rate is increased by a relatively small amount for that causal soft asset. Alternatively, if the enterprise has a low rating on a causal soft asset, then the discount rate is increased by a relatively large amount for that causal soft asset as shown below in Table 32.

TABLE 32
Maximum discount rate = 50%, Causal soft assets = 5
Maximum risk factor/soft asset = 50%/5 = 10%

| Industry Rank on Soft Asset | % of Maximum |
|---|---|
| 1 | 0% |
| 2 | 25% |
| 3 | 50% |
| 4 | 75% |
| 5 or higher | 100% |

| Causal Soft Asset: | Relative Rank | Risk Factor |
|---|---|---|
| Brand | 1 | 0% |
| Channel | 3 | 5% |
| Manufacturing Process | 4 | 7.5% |
| Strategic Alliances | 5 | 10% |
| Vendors | 2 | 2.5% |
| Subtotal | | 25% |
| Base Rate | | 12% |
| Discount Rate | | 37% |

The discount rate for industry options is calculated using a traditional total cost of capital approach in a manner that is well known. After the appropriate discount rates are determined, the value of each real option is calculated using Black Scholes algorithms in a manner that is well known. The real option can be valued using other algorithms including binomial, neural network or dynamic programming algorithms. The software in block 331 values option bots for the industry and the enterprise. Industry option bots utilize the industry cost of capital for all calculations.

Option bots contain the information shown in Table 33.

TABLE 33

| | |
|---|---|
| 1. | Unique ID number (based on date, hour, minute, second of creation) |
| 2. | Creation date (date, hour, minute, second) |
| 3. | Mapping information |
| 4. | Storage location |
| 5. | Industry or Enterprise ID |
| 6. | Real option type (Industry or Enterprise) |
| 7. | Real option |
| 8. | Allocation percentage (if applicable) |

After the option bots are initialized, they activate in accordance with the frequency specified by the user (20) in the system settings table (140). After being activated, the bots retrieve information for the industry and the enterprise from the basic financial system database (143), the external database table (146) and the advanced finance system table (147) as required to complete the option valuation. After the discount has been determined, the value of the real option is calculated using Black Schole's algorithms in a manner that is well known. The resulting values are then saved in the real option value table (162) in the application database (50) before processing advances to a block 332.

The software in block 332 uses the results of the DEA analysis in the prior processing block and the percentage of industry real options controlled by the enterprise to determine the allocation percentage for industry options. The more dominant the enterprise, as indicated by the industry rank for the intangible element of value indicators, the greater the allocation of industry real options. When the allocation of options has been determined and the resulting values stored in the real option value table (162) in the application database (50), processing advances to a block 333.

The software in block 333 checks the system settings table (140) in the application database (50) to determine if the current calculation is a new calculation or a structure change. If the calculation is not a new calculation, a value analysis or a structure change, then processing advances to a software block 341. Alternatively, if the calculation is new, a value analysis or a structure change, then processing advances to a software block 343.

The software in block 341 checks the bot date table (149) and deactivates any cash flow bots with creation dates before the current system date. The software in the block then retrieves the information from the system settings table (140), the metadata mapping table (141) and the component of value definition table (156) as required to initialize cash flow bots for the enterprise in accordance with the frequency specified by the user (20) in the system settings table (140).

Bots are independent components of the application that have specific tasks to perform. In the case of cash flow bots, their primary tasks are to calculate the cash flow for the enterprise for every time period where data is available and to forecast a steady state cash flow for the enterprise. Cash flow is calculated using a well known formula where cash flow equals period revenue minus period expense plus the period change in capital plus non-cash depreciation/amortization for the period. The steady state cash flow is calculated for the enterprise using forecasting methods identical to those disclosed previously in U.S. Pat. No. 5,615,109 to forecast revenue, expenses, capital changes and depreciation separately before calculating the cash flow. The software in block 341 initializes cash flow bots for the enterprise.

Every cash flow bot contains the information shown in Table 34.

TABLE 34

| | |
|---|---|
| 1. | Unique ID number (based on date, hour, minute, second of creation) |
| 2. | Creation date (date, hour, minute, second) |
| 3. | Mapping information |
| 4. | Storage location |
| 5. | Enterprise ID |
| 6. | Components of value |

After the cash flow bots are initialized, the bots activate in accordance with the frequency specified by the user (20) in the system settings table (140). After being activated the bots retrieve the component of value information for the enterprise from the component of value definition table (156). The cash flow bots then complete the calculation and forecast of cash flow for the enterprise before saving the resulting values by period in the cash flow table (161) in the application database (50) before processing advances to a block 342.

The software in block 342 checks the bot date table (149) and deactivates any element life bots with creation dates before the current system date. The software in block 342 then retrieves the information from the system settings table (140), the metadata mapping table (141) and the element of value definition table (155) as required to initialize element life bots for each element and sub-element of value in the enterprise being examined.

Bots are independent components of the application that have specific tasks to perform. In the case of element life bots, their primary task is to determine the expected life of each element and sub-element of value. There are three methods for evaluating the expected life of the elements and sub-elements of value. Elements of value that are defined by a population of members or items (such as: channel partners, customers, employees and vendors) will have their lives estimated by analyzing and forecasting the lives of the members of the population. The forecasting of member lives will be determined by the “best” fit solution from competing life estimation methods including the Iowa type survivor curves, Weibull distribution survivor curves, Gompertz-Makeham survivor curves, polynomial equations and the forecasting methodology disclosed in U.S. Pat. No. 5,615,109. Elements of value (such as some parts of Intellectual Property, i.e. patents) that have legally defined lives will have their lives calculated using the time period between the current date and the expiration date of the element of value or sub-element of value. Finally, elements of value and sub-element of value (such as brand names, information technology and processes) that may not have defined lives and that may not consist of a collection of members will have their lives estimated by comparing the relative strength and stability of the element vectors with the relative stability of the enterprise Competitive Advantage Period (CAP) estimate. The resulting values are stored in the element of value definition table (155) for each element and sub-element of value.

Every element life bot contains the information shown in Table 35.

TABLE 35

| | |
|---|---|
| 1. | Unique ID number (based on date, hour, minute, second of creation) |
| 2. | Creation date (date, hour, minute, second) |
| 3. | Mapping information |
| 4. | Storage location |
| 5. | Element of value or Sub-Element of value |
| 6. | Life estimation method (item analysis, date calculation or relative |
| | CAP) |

After the element life bots are initialized, they are activated in accordance with the frequency specified by the user (20) in the system settings table (140). After being activated, the bots retrieve information for each element and sub-element of value from the element of value definition table (155) as required to complete the estimate of element life. The resulting values are then saved in the element of value definition table (155) in the application database (50) before processing advances to a block 343.

The software in block 343 checks the system settings table (140) in the application database (50) to determine if the current calculation is a new calculation, a value analysis or a structure change. If the calculation is not a new calculation or a structure change, then processing advances to a software block 402. Alternatively, if the calculation is new, a value analysis or a structure change, then processing advances to a software block 345.

The software in block 345 checks the bot date table (149) and deactivates any component capitalization bots with creation dates before the current system date. The software in block 345 then retrieves the information from the system settings table (140), the metadata mapping table (141) and the component of value definition table (156) as required to initialize component capitalization bots.

Bots are independent components of the application that have specific tasks to perform. In the case of component capitalization bots, their task is to determine the capitalized value of the components and subcomponents of value, forecast revenue, expense or capital requirements for the enterprise in accordance with the formula shown in Table 36.

TABLE 36

| | |
|---|---|
| Value = | F_{f1}/(1 + K) + F_{f2}/(1 + K)² + F_{f3}/(1 + |
| | K)³ + F_{f4}/(1 + K)⁴ + (F_{f4} × (1 + g))/(1 + K)⁵) + |
| | (F_{f4} × (1 + g)²)/(1 + K)⁶) . . . + (F_{f4} × (1 + |
| | g)^{N})/(1 + K)^{N+4}) |

Where:
F_{fx} = Forecast revenue, expense or capital requirements for year x after valuation date (from advanced financial system)
N = 0 Number of years in CAP (from prior calculation)
K = Cost of capital − % per year (from prior calculation)
g = Forecast growth rate during CAP − % per year (from advanced financial system)

After the calculation of the capitalized value of every component and sub-component of value is complete, the results are stored in the component of value definition table (156) in the application database (50).

Every component capitalization bot contains the information shown in Table 37.

TABLE 37

| | |
|---|---|
| 1. | Unique ID number (based on date, hour, minute, second of creation) |
| 2. | Creation date (date, hour, minute, second) |
| 3. | Mapping information |
| 4. | Storage location |
| 5. | Enterprise ID |
| 6. | Component of Value (Revenue, Expense or Capital Change) |
| 7. | Sub Component of Value |

After the component capitalization bots are initialized they activate in accordance with the frequency specified by the user (20) in the system settings table (140). After being activated, the bots retrieve information for each component and sub-component of value from the advanced finance system table (147) and the component of value definition table (156) as required to calculate the capitalized value of each component. The resulting values are then saved in the component of value definition table (156) in the application database (50) before processing advances to a block 347.

The software in block 347 checks the bot date table (149) and deactivates any element valuation bots with creation dates before the current system date. The software in block 347 then retrieves the information from the system settings table (140), the metadata mapping table (141), the element of value definition table (155) and the component of value definition table (156) as required to initialize valuation bots for each element and sub-element of value.

Bots are independent components of the application that have specific tasks to perform. In the case of element valuation bots, their task is to calculate the contribution of every element of value and sub-element of value in the enterprise using the overall procedure outlined in Table 5. The first step in completing the calculation in accordance with the procedure outlined in Table 5 is determining the relative contribution of element and sub-element of value by using a series of predictive models to find the best fit relationship between:
1. The element of value vectors and the enterprise components of value, and
2. The sub-element of value vectors and the element of value they correspond to.

The system of the present invention uses 12 different types of predictive models to determine relative contribution: neural network; CART; projection pursuit regression; generalized additive model (GAM); GARCH; MMDR, redundant regression network; boosted Naive Bayes Regression; the support vector method; MARS; linear regression; and stepwise regression to determine relative contribution. The model having the smallest amount of error as measured by applying the mean squared error algorithm to the test data is the best fit model. The “relative contribution algorithm” used for completing the analysis varies with the model that was selected as the “best-fit”. For example, if the “best-fit” model is a neural net model, then the portion of revenue attributable to each input vector is determined by the formula shown in Table 38.

TABLE 38
$( {\sum }_{k = 1}^{k = m} {\sum }_{j = 1}^{j = n} {I}_{jk} \times {O}_{k} / {\sum }_{j = 1}^{j = n} {I}_{ik} ) / {\sum }_{k = 1}^{k = m} {\sum }_{j = 1}^{j = n} {I}_{jk} \times {O}_{k}$
Where
Iⱼₖ = Absolute value of the input weight from input node j to hidden node k
Oₖ = Absolute value of output weight from hidden node k
m = number of hidden nodes
n = number of input nodes

After the relative contribution of each enterprise, element of value and sub-element of value is determined, the results of this analysis are combined with the previously calculated information regarding element life and capitalized component value to complete the valuation of each enterprise contribution, element of value and sub-element using the approach shown in Table 39.

TABLE 39

| | | Element | |
|---|---|---|---|
| Gross Value | Percentage | Life/CAP | Net Value |
| Revenue value = $120 M | 20% | 80% | Value = $19.2 M |
| Expense value = ($80 M) | 10% | 80% | Value = ($6.4) M |
| Capital value = ($5 M) | 5% | 80% | Value = ($0.2) M |
| Total value = $35 M | | | |

| | |
|---|---|
| Net value for this element of value: | Value = $12.6 M |

The resulting values are stored in the element of value definition table (155) for each element and sub-element of value of the enterprise.

Every valuation bot contains the information shown in Table 40.

TABLE 40

| | |
|---|---|
| 1. | Unique ID number (based on date, hour, minute, second of creation) |
| 2. | Creation date (date, hour, minute, second) |
| 3. | Mapping information |
| 4. | Stora e location |
| 5. | Element of Value or Sub-Element of Value |
| 6. | Element of Value ID |

After the valuation bots are initialized by the software in block 347 they activate in accordance with the frequency specified by the user (20) in the system settings table (140). After being activated, the bots retrieve information from the element of value definition table (155) and the component of value definition table (156) as required to complete the valuation. The resulting values are then saved in the element of value definition table (155) in the application database (50) before processing advances to a block 349.

The software in block 349 checks the system settings table to see if the current analysis is a value improvement analysis, if it is, then processing returns to a software block 413. If it isn't a value improvement analysis, then processing advances to a software block 351.

The software in block 351 checks the bot date table (149) and deactivates any residual bots with creation dates before the current system date. The software in block 351 then retrieves the information from the system settings table (140), the metadata mapping table (141) and the element of value definition table (155) as required to initialize residual bots for the enterprise.

Bots are independent components of the application that have specific tasks to perform. In the case of residual bots, their task is to retrieve data as required from the element of value definition table (155) and the component of value definition table (156) and then calculate the residual going concern value for the enterprise in accordance with the formula shown in Table

41.

TABLE 41

| | |
|---|---|
| Residual Going Concern Value = | Total Current-Operation Value − |
| | Σ Financial Asset Values − |
| | Σ Elements of Value |

Every residual bot contains the information shown in Table 42.

TABLE 42

| | |
|---|---|
| 1. | Unique ID number (based on date, hour, minute, second of creation) |
| 2. | Creation date (date, hour, minute, second) |
| 3. | Mapping information |
| 4. | Storage location |
| 5. | Enterprise ID |

After the residual bots are initialized they activate in accordance with the frequency specified by the user (20) in the system settings table (140). After being activated, the bots retrieve information from the element of value definition table (155) and the component of value definition table (156) as required to complete the residual calculation for the enterprise. After the calculation is complete, the resulting values are then saved in the element of value definition table (155) in the application database (50) before processing advances to a block 352.

The software in block 352 checks the bot date table (149) and deactivates any sentiment calculation bots with creation dates before the current system date. The software in block 352 then retrieves the information from the system settings table (140), the metadata mapping table (141), the external database table (146), the element of value definition table (155), the component of value definition table (156) and the real option value table (162) as required to initialize sentiment calculation bots for the enterprise.

Bots are independent components of the application that have specific tasks to perform. In the case of sentiment calculation bots, their task is to retrieve data as required from: the external database table (146), the element of value definition table (155), the component of value definition table (156) and the real option value table (162) and then calculate the sentiment for the enterprise in accordance with the formula shown in Table 43.

TABLE 43
Sentiment = Total Market Value = Total Current-Operation Value −
Σ Real Option Values

Every sentiment calculation bot contains the information shown in Table 44.

TABLE 44
1. Unique ID number (based on date, hour, minute, second of creation)
2. Creation date (date, hour, minute, second)
3. Mapping information
4. Storage location
5. Enterprise ID

After the sentiment calculation bots are initialized they activate in accordance with the frequency specified by the user (20) in the system settings table (140). After being activated, the bots retrieve information from the external database table (146), the element of value definition table (155), the component of value definition table (156) and the real option value table (162) as required to complete the sentiment calculation for each enterprise. After the calculation is complete, the resulting values are then saved in the enterprise sentiment table (166) in the application database (50) before processing advances to a block 353.

The software in block 353 checks the bot date table (149) and deactivates any sentiment analysis bots with creation dates before the current system date. The software in block 353 then retrieves the information from the system settings table (140), the metadata mapping table (141), the external database table (146), the element of value definition table (155), the component of value definition table (156), the real option value table (162), the enterprise sentiment table (166) and the market value factors table (169) as required to initialize sentiment analysis bots for the enterprise.

Bots are independent components of the application that have specific tasks to perform. In the case of sentiment analysis bots, their primary task is to determine the composition of the calculated sentiment by comparing the portion of overall market value that is “caused” by different elements of value and the calculated valuation for each element of value as shown below in Table 45.

TABLE 45

Total Enterprise Market Value = $100 Billion, 10% “caused” by
Brand factors
Implied Brand Value = $100 Billion × 10% = $10 Billion
Valuation of Brand Element of Value = $6 Billion
Increase/(Decrease) in Enterprise Real Option Values due to
Brand = $1.5 Billion
Industry Option Allocation due to Brand = $1.0 Billion
Brand Sentiment = $10 − $6 − $1.5 − $1.0 = $1.5 Billion

Every sentiment analysis bot contains the information shown in Table 46.

TABLE 46
1. Unique ID number (based on date, hour, minute, second of creation)
2. Creation date (date, hour, minute, second)
3. Mapping information
4. Storage location
5. Enterprise ID

After the sentiment analysis bots are initialized, they activate in accordance with the frequency specified by the user (20) in the system settings table (140). After being activated, the bots retrieve information from the system settings table (140), the metadata mapping table (141), the enterprise sentiment table (166) and the sentiment factors table (169) as required to analyze sentiment. The resulting breakdown of sentiment is then saved in the sentiment factors table (169) in the application database (50) before processing advances to a block 401.

### Promotion Development Bots

The flow diagram in FIG. 7 details the processing that is completed by the portion of the application software (400) that analyzes and develops the value-building promotions for the different types of customers identified by the analysis bots in the previous stage of processing. The system of the present invention can also develop value-building promotions without segmenting the customers by setting the maximum number of customer segments in the system settings table (140) to one. However, in one embodiment, the promotions are segmented by customer type.

System processing in this portion of the application software (400) begins in a block 402. The software in block 402 checks the system settings table (140) in the application database (50) to determine if the current calculation is a new calculation or a structure change. If the calculation is not a new calculation or a structure change, then processing advances to a software block 409. Alternatively, if the calculation is new or a structure change, then processing advances to a software block 404.

The software in block 404 checks the bot date table (149) and deactivates any association bots with creation dates before the current system date. The software in block 404 then retrieves the information from the system settings table (140), the operation system table (144), the element of value definition table (155) and the SKU table (170) as required to initialize association bots for each customer group.

Bots are independent components of the application that have specific tasks to perform. In the case of association bots, their primary task is to identify baskets or clusters (hereinafter, baskets) of products or services purchased by each of the different customer groups identified by the analysis bots in the previous stage of processing. The association bots assign a unique id number to each “basket” it identifies and stores the unique id numbers in the cluster id table (157). The cluster id for each basket is also saved in the data record for each SKU in the SKU table (170). The baskets are identified using the apriori algorithm. Other association or market basket algorithms may be used to the same effect. Every association bot contains the information shown in Table 47.

TABLE 47
1. Unique ID number (based on date, hour, minute, second of creation)
2. Creation date (date, hour, minute, second)
3. Mapping information
4. Storage location
5. Customer group
6. Enterprise or Industry
7. Sensitivity factor

When bots in block 404 have identified and stored cluster id's for all the baskets identified for all the customer groups, processing advances to a software block 405.

The software in block 405 checks the bot date table (149) and deactivates any causal association bots with creation dates before the current system date. The software in block 405 then retrieves the information from the system settings table (140), the operation system table (144), the element of value definition table (155), the cluster id table (157) and the SKU table (170) as required to initialize causal association bots for each basket in accordance with the frequency specified by the user (20) in the system settings table (140).

Bots are independent components of the application that have specific tasks to perform. In the case of causal association bots, their primary task is to identify the SKUs that are causal factors in basket purchase decisions. The causal association bot uses the CCU algorithm to identify the causal items in each basket. Other causal association algorithms such as LCD can be used to the same effect. Every causal association bot activated in this block contains the information shown in Table 48.

TABLE 48
1. Unique ID number (based on date, hour, minute, second of creation)
2. Creation date (date, hour, minute, second)
3. Mapping information
4. Storage location
5. Cluster ID

After the causal association bots are initialized they activate in accordance with the frequency specified by the user (20) in the system settings table (140). Once activated, they retrieve the required information from the operation system table (144), the element of value definition table (155), the cluster id table (157) and the SKU table (170) and determine the causal items for each basket. The bot saves the causal item information in the SKU table (170) in the application database (50) and processing advances to block 409.

The software in block 409 checks the system settings table (140) in the application database (50) to determine if the current calculation is a new calculation or a structure change. If the calculation is not a new calculation or a structure change, then processing advances to a software block 412. Alternatively, if the calculation is new or a structure change, then processing advances to a software block 410.

The software in block 410 checks the bot date table (149) and deactivates any forecast bots with creation dates before the current system date. The software in block 410 then retrieves the information from the system settings table (140), the operation system table (144), the advanced finance system table (147), the SKU table (170) and the SKU Life table (171) as required to initialize forecast bots for the causal SKUs identified by the bots in block 405 and their vendors in accordance with the frequency specified by the user (20) in the system settings table (140).

Bots are independent components of the application that have specific tasks to perform. In the case of forecast bots, their primary task is to update forecasts for the causal SKUs and their vendors. The forecast bots check the SKU life table for any impending obsolescence and use a variety of forecast methods as described in the related U.S. Pat. No. 5,615,109 a “Method of and System for Generating Feasible, Profit Maximizing Requisition Sets” to forecast demand for the causal SKUs and their vendors. Every forecast bot activated in this block contains the information shown in Table 49.

TABLE 49
1. Unique ID number (based on date, hour, minute, second of creation)
2. Creation date (date, hour, minute, second)
3. Mapping information
4. Storage location
5. SKU or Vendor
6. Enterprise

After the forecast bots are initialized they activate in accordance with the frequency specified by the user (20) in the system settings table (140). Once activated, they retrieve the required information and select the best fit forecast in accordance with the procedure described in the related U.S. Pat. No. 5,615,109 a “Method of and System for Generating Feasible, Profit Maximizing Requisition Sets”. After the forecast bots complete their calculations for each causal item and for the vendors of causal items, the bots save the updated forecasts in the advanced finance system table (147) in the application database (50) and processing advances to a block 411.

The software in block 411 checks the bot date table (149) and deactivates any supply chain bots with creation dates before the current system date. The software in block 411 then retrieves the information from the system settings table (140), the operation system table (144), the advanced finance system table (147), the element of value definition table (155), the SKU table (170) and the supply chain system table (174) as required to initialize supply chain bots for the causal SKUs identified by the bots in block 405 and their vendors in accordance with the frequency specified by the user (20) in the system settings table (140).

Bots are independent components of the application that have specific tasks to perform. In the case of supply chain bots, their primary task is to rank the vendors for each causal SKU on the basis of their ability to provide items in the required timeframe. The supply chain bots also forecast the net price per unit after all volume discounts are accounted for in accordance with the procedure described in the related U.S. Pat. No. 5,615,109 a “Method of and System for Generating Feasible, Profit Maximizing Requisition Sets”. Every supply chain bot contains the information shown in Table 50.

TABLE 50
1. Unique ID number (based on date, hour, minute, second of creation)
2. Creation date (date, hour, minute, second)
3. Mapping information
4. Storage location
5. SKU
6. Vendors

After the supply chain bots are initialized they activate in accordance with the frequency specified by the user (20) in the system settings table (140). Once activated, they retrieve the required information and rank the vendors for each causal SKU on the basis of item availability and forecast the net price to the company after volume discounts are considered in a manner similar to that described in the related U.S. Pat. No. 5,615,109 a “Method of and System for Generating Feasible, Profit Maximizing Requisition Sets”. After the supply chain bots rank the vendors for each causal item, the bots save the updated supplier rankings in the supplier ranking table (175) in the application database (50). The calculated rankings, and any causal items that have insufficient supply are displayed to the user (20) using the supplier selection and warning window (706) for inspection before processing advances to software block 412.

The software in block 412 checks the system settings table (140) in the application database (50) to determine if the current calculation is a new calculation or a structure change. If the calculation is not a new calculation or a structure change, then processing advances to a software block 502. Alternatively, if the calculation is new or a structure change, then processing advances to a software block 413.

The software in block 413 checks the bot date table (149) and deactivates any value analysis bots with creation dates before the current system date. The software in block 413 then retrieves the information from the system settings table (140), the operation system table (144), the advanced finance system table (147), the element of value definition table (155), the SKU table (170) and the supplier ranking table (175) as required to initialize value analysis bots in accordance with the frequency specified by the user (20) in the system settings table (140).

Bots are independent components of the application that have specific tasks to perform. In the case of value analysis bots, their primary task is to generate and forecast the value impact of promotional offerings for the causal SKUs and for the generic promotional offerings the user (20) specified in the system settings table (140) by customer group. The value analysis bots also examine the impact of generic promotions on customers that can't be classified during the web site visit. The analysis of promotional offerings considers the likelihood of acceptance based on history for customers in each segment (note: a segment can contain only one individual), the expected impact on purchase patterns and the expected impact on customer retention. Every value analysis bot contains the information shown in Table 51.

TABLE 51
1. Unique ID number (based on date, hour, minute, second of creation)
2. Creation date (date, hour, minute, second)
3. Mapping information
4. Storage location
5. Customer group
6. Causal SKU or Promotion

After the value analysis bots are initialized by the software in block 413 they activate in accordance with the frequency specified by the user (20) in the system settings table (140). After being activated, the bots retrieve information as required to revise the forecasts of element of value and component of value performance and updating the calculations completed in the prior stage of processing to forecast the value impact of the proposed promotions. The resulting forecast of value impacts are then saved in the SKU table (170) in the application database (50) and the bots created for the value analysis in prior stages of processing are deactivated before processing advances to a block 414.

The software in block 414 checks the bot date table (149) and deactivates any sales process optimization with creation dates before the current system date. The software in block 414 then retrieves the information from the system settings table (140), the SKU table (170) and the optimized offer table (173) as required to initialize sales process optimization bots in accordance with the frequency specified by the user (20) in the system settings table (140).

Bots are independent components of the application that have specific tasks to perform. In the case of sales process optimization bots, their primary task is to rank the promotions by customer type on the basis of forecast value impact for all causal items where there is sufficient stock in inventory and the supply chain to meet forecast demand and for the generic promotions the user (20) specified in the system settings table (140). Every sales process optimization bot contains the information shown in Table 52.

TABLE 52
1. Unique ID number (based on date, hour, minute, second of creation)
2. Creation date (date, hour, minute, second)
3. Mapping information
4. Storage location
5. Causal SKU

After the sales process optimization bots are initialized by the software in block 414 they activate in accordance with the frequency specified by the user (20) in the system settings table (140). After being activated, the bots retrieve information as required to complete the ranking by value impact. The resulting ranking of promotional offerings for causal SKUs are then saved in the optimized offer table (173) in the application database (50) before processing advances to a software block 415.

The software in block 415 checks the bot date table (149) and deactivates any process optimization with creation dates before the current system date. The software in block 415 then retrieves the information from the system settings table (140), the element of value definition table (155), component of value definition table (156), real option value table (162), the sentiment factors table (173) as required to initialize process optimization bots in accordance with the frequency specified by the user (20) in the system settings table (140).

Bots are independent components of the application that have specific tasks to perform. In the case of process optimization bots, their primary task is to identify a set of changes to one or more process value drivers for each process that will optimize one or more aspects of enterprise financial performance. While a number of methods can be used to identify an optimal set of value driver changes, process optimization calculations are completed using genetic algorithms, quasi monte carlo simulations and multi-criteria optimizations for combinations of two or more aspects of financial performance. These optimization bots can also be used to optimize any element of value. Every process optimization bot contains the information shown in Table 53.

```
TABLE 53
1. Unique ID number (based on date, hour, minute, second of creation)
2. Creation date (date, hour, minute, second)
3. Mapping information
4. Process
5. Aspect of Financial Performance: Revenue, Expense, Capital Change,
  Current Operation Value, Real Option Value, Market Value and
  combinations thereof
```

After the process optimization bots are initialized by the software in block 415 they activate in accordance with the frequency specified by the user (20) in the system settings table (140). After being activated, the bots retrieve information as required to identify a set of changes to one or more process value drivers that will optimize one or more aspects of enterprise financial performance. The resulting sets of changes are then saved in the value driver change table (167) in the application database (50) before processing advances to a software block 502.

### Output

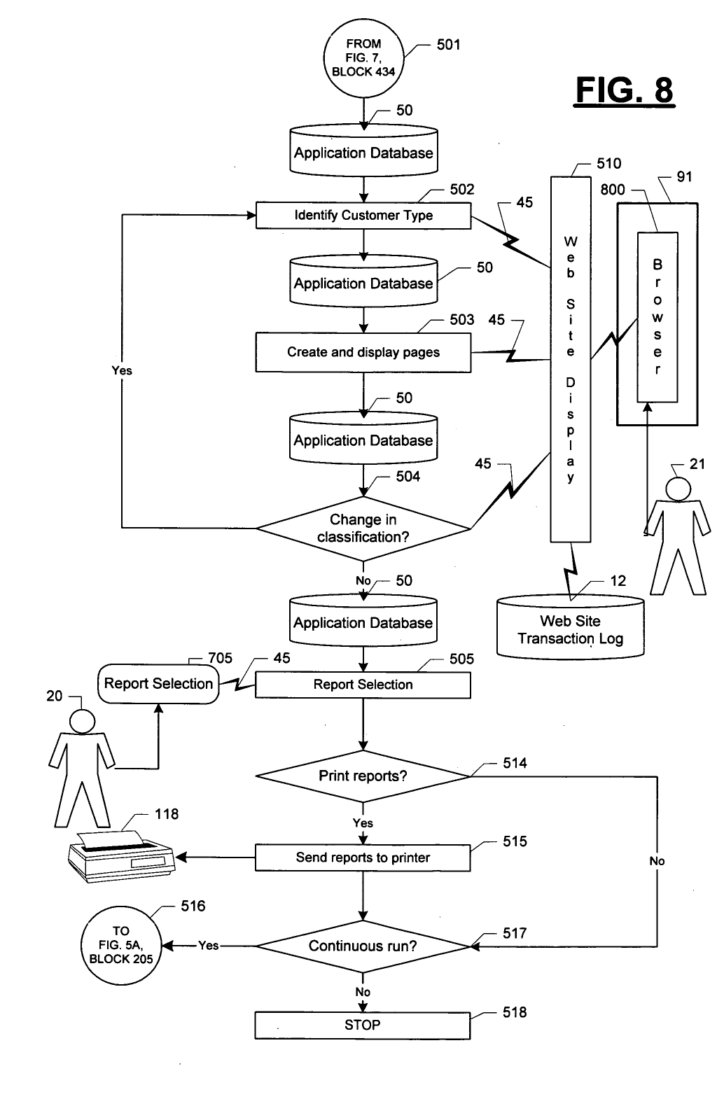

The flow diagram in FIG. 8 details the processing that is completed by the portion of the application software (500) that generates and displays a web site containing the sales process optimization offerings developed in the prior stages of processing. Processing in this portion of the application starts in software block 502.

The software in block 502 receives company or third party “cookies” via a network (45) from the web site display software (510). The web site display software (510) can be any of a number of web site publishing packages such a Visual Interdev that integrate with back end databases and have the ability to generate web pages “on the fly” for unique visitors. The web site display software (510) obtains the “cookie”information in a manner that is well known when the browser software (800) in the customer's internet appliance (91) connects with the web site display software (510) via a network (45). The software in block 502 checks the external database table (146), the element of value definition table (155) and the web log data table (172) as required to identify the group that the customer (21) fits into. If no classification can be made, then the customer id is “unknown”. After storing this information in the web log data table (172), processing advances to a block 503.

The software in block 503, checks the optimized offer table (173) to identify the appropriate optimized offer for the customer (21) and passes that information to the web site display software (510). The web site display software (510) in turn generates a new page displaying the appropriate optimized offer for the customer (21). After the optimized offer information is transmitted, processing advances to a software block 504.

The software in block 504 monitors the activity for each customer (21) connected to the web site display (510) to see if they provide information (for example by filling out a survey or providing shipping information) that might change the classification that was made by the software in block 502. If a potential change is detected, then processing returns to block 502 where the customer may be reclassified and the processing described in the preceding paragraphs repeats itself. Alternatively, if no potential change is detected, then processing advances to a block 505.

The software in block 505 displays the report selection window (705) to the user (20). The user selects reports for printing. If the user (20) selects any reports for printing, then the information regarding the reports selected is saved in the reports table (164). After the user (20) has finished selecting reports, processing advances to a software block 514.

The software in block 514 checks the reports tables (164) to determine if any reports have been designated for printing. If reports have been designated for printing, then processing advances to a block 515. The software in block 515 sends the designated reports to the printer (118). After the reports have been sent to the printer (118), processing advances to a software block 517. Alternatively, if no reports were designated for printing then processing advances directly from block 514 to block 517.

The software in block 517 checks the system settings table (140) to determine if the system is operating in a continuous run mode. If the system is operating in a continuous run mode, then processing returns to block 205 and the processing described previously is repeated. Alternatively, if the system is not running in continuous mode, then the processing advances to a block 518 where the system stops.

Thus, the reader will see that the system and method described above transforms extracted transaction data, corporate information and information from the internet into detailed valuations for the enterprises in the organization and for specific elements of value within the enterprise particularly the supplier and customer elements of value. The level of detail contained in the business valuations allows users of the system to monitor and manage the customer acquisition and retention process in a manner that is superior to that available to users of: indiscriminant discounting, simple lifetime-customer-value analyses, traditional accounting systems and business valuation reports.

While the above description contains many specificity's, these should not be construed as limitations on the scope of the invention, but rather as an exemplification of one preferred embodiment thereof. Accordingly, the scope of the invention should be determined not by the embodiment illustrated, but by the appended claims and their legal equivalents.

1. A computer supported sales method, comprising:
preparing data from a plurality of business systems for using in processing,
creating a model that quantifies a net impact of one or more elements and sub-elements of value on a market value of a business that has at least one sales process element and at least one sub-element of customer value by a category of value by learning from said data,
defining one or more baskets purchased from the business and an associated causal SKU for each basket by sub-element of customer value, and
identifying a set of sales process variables that will optimize one or more aspects of business financial performance for each basket using said model
where the set of sales process variables are selected from the group consisting of a causal SKU, an optimized offer for a causal SKU, a vendor selection for each SKU in the basket, an expected delivery date for each SKU in the basket and combinations thereof, and where the aspects of financial performance are selected from the group consisting of revenue, expense, capital change, current operation value, real option value, market value, vendor value, customer value and combinations thereof.

2. The method of claim 1 that further comprises:
obtaining information that identifies a sub-element of customer value for a potential customer,
presenting a value maximizing offer for said sub-element of customer value to the potential customer using an interactive sales process, and
optionally, completing one or more sales transactions in an automated fashion.

3. The method of claim 1 where a category of value from the group consisting of current operation, real option, market sentiment and combinations thereof.

4. The method of claim 1 where creating a model further comprises using composite applications to complete a series of tasks selected from the group consisting of:
identifying the events that drive value and their associated business context, developing one or more predictive models from transaction data, identifying one or more previously unknown item performance indicators, discovering one or more previously unknown value drivers, identifying one or more previously unknown relationships between one or more value drivers, identifying one or more previously unknown relationships between one or more elements of value, quantifying one or more inter-relationships between value drivers, quantifying one or more impacts between elements of value, developing one or more composite variables, developing one or more vectors, developing one or more causal element impact summaries, identifying a best fit combination of predictive model algorithm and element impact summaries for modeling enterprise market value and each of the components of value, building causal predictive models using transaction data, determining a net element of value impact for each category of value, determining a relative strength of the elements of value between two or more enterprises, developing one or more real option discount rates, calculating one or more real option values, calculating an enterprise market sentiment value by element, simulating a financial performance and combinations thereof.

5. The method of claim 1 wherein the apriori algorithm is used to determine the content of the baskets typically purchased by each customer sub element of value and a CCU or LCD causal association algorithm is used to identify one or more causal SKU's for each basket.

6. The method of claim 1 where one or more elements of value are selected from the group consisting of alliances, brands, channels, customers, customer relationships, employees, equipment, intellectual property, investors, partnerships, processes, production equipment, vendors, vendor relationships and combinations thereof.

7. The method of claim 1 wherein a sales process is selected from the group consisting of e-commerce sales, sales from on-line exchanges, telemarketing and combinations thereof.

8. A computer readable medium having sequences of instructions stored therein, which when executed cause the processor in a computer to perform a process method, the method steps comprising:
preparing data from a plurality of business systems for use in processing,
obtaining a process specification,
creating an enterprise model that quantifies a net impact of each of one or more elements of value on a value of a business by a category of value by learning from said data,
identifying one or more relationships between one or more specified process outputs and the elements of value in said model, and
determining a set of process variable values that will optimize one or more aspects of business financial performance using said model and relationships.

9. The computer readable medium of claim 8 where category of value is selected from the group consisting of current operation, real options, market value and combinations thereof.

10. The computer readable medium of claim 8 where one or more aspects of business financial performance are selected from the group consisting of revenue, expense, capital change, current operation value, real option value, market value and combinations thereof.

11. The computer readable medium of claim 8 wherein a process is an interactive sales process and the process variables include are selected from the group consisting of promotional prices, causal SKU's by basket, vendors, vendor order quantities and combinations thereof.

12. The computer readable medium of claim 8 where optimizations are completed using methods from the group consisting of genetic algorithms, multi criteria optimization models and Monte Carlo simulations.

13. The computer readable medium of claim 8 where processes are selected from the group consisting of purchasing, replenishment, sales and combinations thereof.

14. The computer readable medium of claim 8 where a process specification includes attributes from the group consisting of process budget, process operating factors, process outputs, process variables, the relationship between process variables, budget and outputs and combinations thereof.

15. A process method, comprising:
preparing transaction data from a plurality of business systems for using in processing by integrating and converting data from each system in accordance with a common metadata standard,
obtaining a process specification,
creating an enterprise model that quantifies a net contribution of each of one or more elements of value to a value of a business by learning from said data,
identifying one or more relationships between one or more specified process outputs and the elements of value in said model, and
determining a set of process variable values that will optimize one or more aspects of business financial performance using said model and relationships
where the aspects of financial performance are selected from the group consisting of revenue, expense, capital change, current operation value, real option value, market value, vendor value, customer value and combinations thereof.

16. The computer readable medium of claim 15 where a net contribution of one or more elements and sub-elements of value is the direct impact of the element and sub-element on business value net of any impact on any other elements or sub-elements of value.

17. The computer readable medium of claim 15 where creating a model further comprises using composite applications to automatically complete a series of tasks selected from the group consisting of: identifying the events that drive value and their associated business context, developing one or more predictive models from transaction data, identifying one or more previously unknown item performance indicators, discovering one or more previously unknown value drivers, identifying one or more previously unknown relationships between one or more value drivers, identifying one or more previously unknown relationships between one or more elements of value, quantifying one or more inter-relationships between value drivers, quantifying one or more impacts between elements of value, developing one or more composite variables, developing one or more vectors, developing one or more causal element impact summaries, identifying a best fit combination of predictive model algorithm and element impact summaries for modeling enterprise market value and each of the components of value, building causal predictive models using transaction data, determining a net element of value impact for each category of value, determining a relative strength of the elements of value between two or more enterprises, developing one or more real option discount rates, calculating one or more real option values, calculating an enterprise market sentiment value by element, simulating a financial performance and combinations thereof.

18. The computer readable medium of claim 15 wherein an apriori algorithm is used to determine the content of the baskets typically purchased by each customer sub element of value and a CCU or LCD causal association algorithm is used to identify one or more causal SKU's for each basket.

19. The computer readable medium of claim 15 where one or more elements of value are selected from the group consisting of alliances, brands, channels, customers, customer relationships, employees, equipment, intellectual property, investors, partnerships, processes, production equipment, vendors, vendor relationships and combinations thereof.

20. The computer readable medium of claim 15 wherein a common metadata standard is selected from the group consisting of xml and metadata coalition standards.
